(19) United States
(12) Patent Application Publication
(10) Pub. No.: US 2015/0125042 A1
(43) Pub. Date: May 7, 2015

(54) METHOD AND SYSTEM FOR DATA COLLECTION USING PROCESSED IMAGE DATA

(71) Applicants: Stephen Haden, Goshen, KY (US); Amine Ben Khalifa, Louisville, KY (US); Jessica Hamilton, Louisville, KY (US)

(72) Inventors: Stephen Haden, Goshen, KY (US); Amine Ben Khalifa, Louisville, KY (US); Jessica Hamilton, Louisville, KY (US)

(73) Assignee: SMARTLANES TECHNOLOGIES, LLC, Goshen, KY (US)

(21) Appl. No.: 14/510,073

(22) Filed: Oct. 8, 2014

Related U.S. Application Data
(60) Provisional application No. 61/961,227, filed on Oct. 8, 2013.
(60) Provisional application No. 61/964,845, filed on Jan. 16, 2014.

(51) Int. Cl. G06K 9/32; G06K 9/18

(52) U.S. Cl. CPC G06K 9/325; G06K 9/18
USPC 382/105

(57) ABSTRACT

The present invention relates to a system and method for capturing data from vehicles and processing the captured vehicle data to generate a set of demographic data based on the set of captured demographic data. Specifically, the invention captures video or image data of one or more vehicles at a business location. Additional data may be gathered and transmitted with the image data. The captured data may then be compressed and sent to a remote server for further processing. The data is processed to identify a set of salient objects and to generate a set of demographic data from the identified set of objects. The demographic data is then associated one or more customer records.

### CROSS REFERENCE TO RELATED APPLICATION

The present application claims benefit of priority to U.S. Prov. Pat. Application Ser. No. 61/961,227, filed Oct. 8, 2013, and entitled SYSTEM AND METHOD FOR INFERENCE AND CALCULATION OF DEMOGRAPHICS AND PREFERENCES OF INDIVIDUALS IN A LOCATION USING VIDEO DATA OF VEHICLES (Haden et al.), and to U.S. Prov. Pat. Application Ser. No. 61/964,845, filed Jan. 16, 2014, and entitled METHOD, SYSTEM, AND COMMUNICATION PROTOCOL FOR IMAGE DATA REDUCTION (Haden et al.) both of which are hereby incorporated by reference herein in its entirety.

### BACKGROUND OF THE INVENTION

In the field of demographic data collection, various methods and techniques exist for collecting data on the demographics data for customers, e.g., for a particular business or shopping center. Additionally, various systems and methods exist for obtaining and processing demographic data for geographic regions. Systems and methods that currently exist for determining the demographics of consumers at a location for the purpose of marketing and research include consumer surveys, census data, point of sale data and mobile device data to infer the population demographics of the location as well as its trade area. Stores often have access to video data from in-store and parking lot security systems that may be used in collecting data.

Current methods provide a sample of the population from such sources of data. Additionally, current video systems are not adapted to gather potentially available consumer demographic information including age, gender, income, education, and purchasing preferences.

There exists a need for a system and method for the inference and calculation of demographics and preferences of individuals in a location using video data of vehicles. There also exists a need for a system and method that is capable of counting the number and the frequency of visits of vehicles to specified area, determine the origin of the vehicle, and the length of time the vehicle is at the location.

Current known systems in use in the marketplace provide for the capture of vehicle license plate numbers and state of origin only. What is needed is a system that can capture a broader scope of relevant data typically appearing on the license plate including county, registration date, and specialized plate designations (such as Veteran, Wildlife Supporter, Cancer Awareness etc). What is needed is a system that can extract additional data from vehicles to include color of vehicle, signage on vehicle (e.g. bumper stickers), and number of occupants in vehicle. Additionally, existing systems and methods are slow to process the data collected and require a substantial systems infrastructure to process the data efficiently.

In addition to the problems presented in the area of demographic data collection and analysis, additional challenges are presented in the communication and storage of raw collected demographic data. Various systems and applications exists that use different kinds of moving and still image compression techniques to reduce the file size of a video or an image for the purpose of storage in a local physical medium or for transmission over a communication line. Most existing techniques can be classified into three classes: 1) treat the image as an equally important block of information, and therefore apply uniform compression to the whole image to produce a reduced size one; 2) apply adaptive compression which uses higher compression ratios for less important regions, and produce the reduced size image; or 3) divide the image into characteristic regions and background regions, and then characteristic regions and background regions are compressed at different compression rates, the resulting layers are then expanded and multiplexed to form either a single stream of compressed data, or two streams, one for background and one for the characteristic regions.

U.S. Pat. No. 8,073,275 relates to an image adaptation technique that reduces the image size to comply with certain target characteristics, such as file size and/or resolution. This technique can be classified into class 1 as it works on the whole image and is suitable for media adaption to different devices and screen sizes rather than reducing the amount of image data.

U.S Patent Application Publication No. 2012/0275718 presented an adaptive compression technique that allocates higher resolution to predetermined target object, this method falls under class 2.

U.S. Pat. No. 8,064,706 teaches a system of compressing an image by segregating objects within the image, and comparing each of the segregated objects to a background part. Its object is to recognize common objects and replace them with special tags as to reduce the redundancy within the image, thus, achieving higher compression ratios. It can be classified into class 3.

The techniques disclosed in U.S Patent Application Publication No. 2010/0119156 and U.S Patent Application Publication No. 2013/0121588 relate to means of compressing moving or still images by adaptively compressing different regions of interests at different compression ratios, the output is then the compressed multiplexed regions of interests or background.

The aforementioned techniques tend to improve the compression either of a whole image or for regions of interests within the image. Another advantage is the use of single encoder versus multiple encoders for different regions of interest.

These known systems store data represented by the image (i.e. regions of interest and background) and have as an object to produce a compressed image. What is needed is a method to reduce the image data and conserve 100% of information requested by third party receivers. For instance, some systems may request to receive part of the information enclosed within the image, such as the indication of presence of an object, or request the reception of an object of interest that comply with certain size constraints. Moreover, some conflicts between constraints may occur, making harder optimizing objects of interests within an image for different receiving parties. What is needed is a system and method that may efficiently extract such information to send to a requesting system instead of transmitting a full image either compressed or not. Properly formatting the transmitted data will reduce the needed bandwidth required for data transfer.

### SUMMARY OF THE INVENTION

The present invention is a system and method for the inference and calculation of demographics and preferences of individuals in a location using video data of vehicles, and a communication protocol that reduces the size of image data transmitted over a communication line while respecting constraints imposed by remote requesting parties. Specifically, the system and method of the present invention allows for the inference and calculation of demographic information including but not limited to age, gender, income level, marital status, and purchasing preferences of individuals in a location using video data of vehicles. The system may also gather empirical data related to vehicle travel patterns and the number and rate of visits to certain locations. These patterns may be used to infer home and work addresses as well as preferred commuting routs between home, work, and other locations. Empirical data and inferred data may either be utilized separately or in combination to provide customer data to a user. Video data used in the present invention may be reduced in size for transmission and analysis to respect constraints imposed by the system receiving and processing the image data.

The system is composed of one or more monitoring devices that collect data necessary to determine the consumer demographic data and purchasing preferences. Specifically, a monitoring device in accordance with the present invention may be installed in a fixed location near a road or an area of vehicle incoming, exiting, or parked traffic.

These monitoring devices are adapted to collect image data for processing, either locally or remotely, to derive and transmit demographic data related to the image data. The present invention collects data from a variety of sources and provides an end-to-end solution for collecting the data, mapping the data to vehicle data, and storing, processing and displaying the collected data. The present invention improves on existing methods that may only collect vehicle license plate data or vehicle make and model data.

Demographic data collected from analyzed and processed video images may also be derived from a number of sources to include academic publications, marketing research, and insurance data. The demographic and preference information gathered provides value to a number of different customer segments. Demographic data may be used in a variety of ways, including, but not limited to: by malls and shopping centers to assess types of client stores most suited for their locations and to more accurately assess lease rates; by retail stores to develop their in-store marketing and product mix to achieve higher sales as well as gain an understanding of their marketing return on investment; by manufacturers of retail goods to determine most effective in-store advertising displays and shelf stocking strategies to use at retail stores that sell their products; by marketers to determine most effective types of advertising at a given location; by government agencies to assess traffic patterns and determine best use of resources to serve needs of public; by academic and marketing research agencies to assess consumer movement and shopping patterns from local to national level. Data collected and processed by the present invention may also be used to derive the optimum site location for new commercial development efforts.

The demographic data may also be used to: identify flow of traffic of particular demographics on a time-series basis, e.g., to identify if a particular age range is within a commercial area within a time as opposed to another age range; calculate the interest of a particular demographic with other data points, e.g., to correlate the sales or activities of a particular area that has a larger proportion of eco-conscious individuals to determine what other products these individuals purchase; validate census and survey consumer intelligence data, e.g., to compare census data of a region with the data obtained within smaller commercial or residential areas within that region; generate and run models to predict movements within an area, e.g., a retailer may use this demographic data in a model in order to predict consumer movements to target timing of marketing activities or product mix; visualize demographic structure of an area, e.g., use the data or programming to visualize consumer movements; using system for security purposes, e.g., use cameras to deter criminal behavior, identify shop-lifting demographics, or alert when particular car is within area; identify economic health of an area, e.g., determine increase or decrease of a particular demographic within and area to diagnose economic issues within that area; improve transportation understanding of an area, e.g., identify whether an area has a flow of heavier or light-weight vehicles to assist in traffic system planning, road improvements; and calculate the volume of commercial or passenger traffic, or derive the quantity of people or goods carried on the road at a measured location.

During the installation process, appropriate measurements are made to establish the spatial relationship between the monitoring device and the traffic area. The monitoring device is primarily comprised of a camera to collect images or video of the traffic area and vehicles and individuals in the visual field of the monitoring device. The monitoring device is also adapted to reduce the size of the raw image data while maintaining integrity of key image features for later processing and analysis.

In machine vision applications such as object recognition or optical character recognition (OCR), an object or a block of text needs to have a certain minimum size within an image to be recognized with good accuracy. Imposing a minimum size (minimum height, or minimum width) on a target object will consequently impose a minimum size on the image containing the object. This is under the hypothesis that the object of interest is within a fixed distance from the image capturing device, because if not, moving the object closer will increase its size within the image without requiring the size of whole image to be bigger.

The method of the present invention relates not only to the collection of information, but also the transmission and processing of the collected information. Specifically, the method of the present invention contemplates discreet or continuous data transmission of collected information from remote monitoring devices, each of which monitors a particular traffic area, to a central processing facility where a computational analysis is conducted to collect data related to vehicle items in the visual field and infer population demographic and preference information. The resulting vehicle and demographic data can be further analyzed and compiled to determine the consumer properties of the location.

Embodiments of the present invention provide methods, systems, and a communication protocol to coordinate the actions and communications between a sender party and a receiver party in order to reduce the amount of image data transferred over a communication line while complying with both parties' requirements.

In a first embodiment, the present invention provides: an image acquisition unit capable of capturing images from a camera device at diffident sizes as supported by the device; an object-models unit holding computer vision and machine learning models for detecting preset objects, an exemplary model could be, but is not limited to, HAAR CASCADE description of face data; an object detection unit to detect the regions of objects within an image and output the coordinates of the smallest bounding box containing the object; a communication unit for receiving and sending messages defined by the protocol part of the object of this invention, example messages are the constraints on the sizes of the detected objects as well as other session's setup and control related messages; a decision unit to resolve the constraint, such as the ones mentioned in the previous paragraphs, and output the smallest permitted size for each detected object; a protocol control unit to manage the communication logic between image reduction units and remote machine vision applications; an image cropping unit having as input an original image and coordinates of a given bounding box and output an image containing just the region of the bounding box; an image resizing unit to resize an image to its target size; and an object recognition unit to provide minimum required sizes for objects and is capable to communicate using the protocol part of this invention.

The invention furthermore provides ways to run the aforementioned units and steps in a synchronous or asynchronous mode to achieve image data reduction while respecting constraints and thus reducing the required bandwidth of a communication line. By providing asynchronous mode the image transfer will be outage tolerant.

In one embodiment, the present invention provides a system for collecting demographic data, the system comprising: a set of data collection devices adapted to capture a set of image data from a vehicle; at least one server communicatively connected through a network to the set of data collection devices, the server comprising: a database adapted to store data received from the set of data collection devices; at least one processor adapted to process the set of image data to generate a set of salient objects identified from the set of image data, the at least one processor further adapted to generate a set of processed data from the identified set of salient objects, to generate a set of customer data based in part on the set of customer data, and to associate the set of customer data with a customer; a collected data database adapted to store the set of customer data; and an output module adapted to generate and transmit a set of output data comprising data from the set of customer data.

The embodiment of the system may further comprise wherein the set of data collection devices comprises a set of video cameras and a set of wireless network scanning devices; wherein the set of processed data comprises customer preferences, vehicle information, residence information; wherein the at least one processor is further adapted to: identify a vehicle license plate number, and generate an encrypted license plate identifier; wherein the at least one processor is further adapted to generate a confidence score; wherein the at least one processor is further adapted to perform optical character recognition on the set of data; wherein the at least one processor is further adapted to identify the set of salient objects as either image data or text data; wherein the at least one processor is further adapted to: identify images or video sequences in the set of data that contain vehicles, generate a set of vehicle images, and determine at least one region of interest in the set of vehicle images; wherein the set of data collection devices are mounted on a mobile platform; wherein the set of data collection devices are selected from the group consisting of: video cameras, wireless network scanners, and geo-location gathering devices; and wherein: the set of data collection devices are further adapted to collected a set of empirical data, and the at least one processor is further adapted to associate the set of empirical data with the customer.

In another embodiment, the present invention provides a method for collecting data, the method comprising: collecting a set of unprocessed data from a set of vehicles at a first location; transmitting the set of unprocessed data to a temporary storage location; retrieving the unprocessed data from the temporary storage location; processing the unprocessed data to generate a set of processed data; generating a set of preferences from the set of processed data; associating the set of processed data, the set of unprocessed data, and the set of preferences with one or more entities; generating a set of reports from the set of processed data and the set of preferences.

The embodiment of the method may further comprise collecting a set of video data from a set of video cameras and a set of wireless network data from a set of wireless network scanning devices; wherein the set of processed data comprises customer preferences, vehicle information, residence information; identifying a vehicle license plate number, and generating an encrypted license plate identifier; generating a confidence score; wherein the processing further comprises performing optical character recognition on the set of data; identifying the set of salient objects as either image data or text data; identifying images or video sequences in the set of data that contain vehicles, generating a set of vehicle images, and determining at least one region of interest in the set of vehicle images; and wherein the collecting further comprises collecting data from data collection devices mounted on a mobile platform.

In yet another embodiment, the present invention provides a method for reducing the size of an image, the method comprising: receiving an image frame from an image capture device; detecting a set of predefined objects in the image; determining the size of each of the objects in the set of predefined objects; generating a compressed image, the generating comprising: determining if each object in the set of objects satisfies a minimum acceptable object size for the object, and if the size of the object does not satisfy the minimum acceptable object size, generating a resized object; determining if the size of the image frame satisfies a minimum acceptable image size for the frame, and if the size of the image frame does not satisfy the minimum acceptable image size, requesting a resized image from the image capture device; transmitting the compressed image.

The embodiment of the method may further comprise capturing the image frame at different image sizes; and cropping the image frame based on one or more of the detected objects.

### BRIEF DESCRIPTION OF THE DRAWINGS

In order to facilitate a full understanding of the present invention, reference is now made to the accompanying drawings, in which like elements are referenced with like numerals. These drawings should not be construed as limiting the present invention, but are intended to be exemplary and for reference.

FIG. 1 provides an embodiment of a block diagram of an image reduction processing system according to the present invention.

FIG. 2 provides an embodiment of an example image subject to data reduction and containing according to the present invention.

FIG. 3 provides an embodiment of a flowchart illustrating the processing of an example image according to the present invention.

FIG. 4 provides a flowchart illustrating an embodiment of the image reduction process according to the present invention.

FIG. 5 provides a flowchart illustrating an embodiment of resolution constraints of the image reduction process according to the present invention.

FIG. 6 provides a flowchart illustrating an embodiment of the image resizing process according to the present invention.

FIG. 7 provides an embodiment of a sequence diagram of the protocol object according to the present invention.

FIG. 8 provides an embodiment of the system for collecting and analyzing demographics data from an image according to the present invention.

FIG. 9 provides a flowchart illustrating an embodiment of the process for collecting and analyzing demographics data from an image according to the present invention.

FIG. 10 provides a detailed flowchart illustrating an embodiment of the process for collecting and analyzing demographics data from an image according to the present invention.

FIG. 11 provides a perspective view of an embodiment of the system for collecting demographics data from vehicles as implemented in a business parking lot.

FIG. 12 provides an illustration of a vehicle and indicia on the vehicle that may be processed for demographic data collection according to one embodiment of the present invention.

FIG. 13 provides an embodiment of the data processing algorithm according to the present invention.

FIGS. 14-23 provide a series of screenshots illustrating an exemplary user interface and data dashboard according to the present invention.

### DETAILED DESCRIPTION OF THE INVENTION

The present invention is not to be limited in scope by the specific embodiments described herein. It is fully contemplated that other various embodiments of and modifications to the present invention, in addition to those described herein, will become apparent to those of ordinary skill in the art from the foregoing description and accompanying drawings. Thus, such other embodiments and modifications are intended to fall within the scope of the following appended claims. Further, although the present invention has been described herein in the context of particular embodiments and implementations and applications and in particular environments, those of ordinary skill in the art will appreciate that its usefulness is not limited thereto and that the present invention can be beneficially applied in any number of ways and environments for any number of purposes. Accordingly, the claims set forth below should be construed in view of the full breadth and spirit of the present invention as disclosed herein.

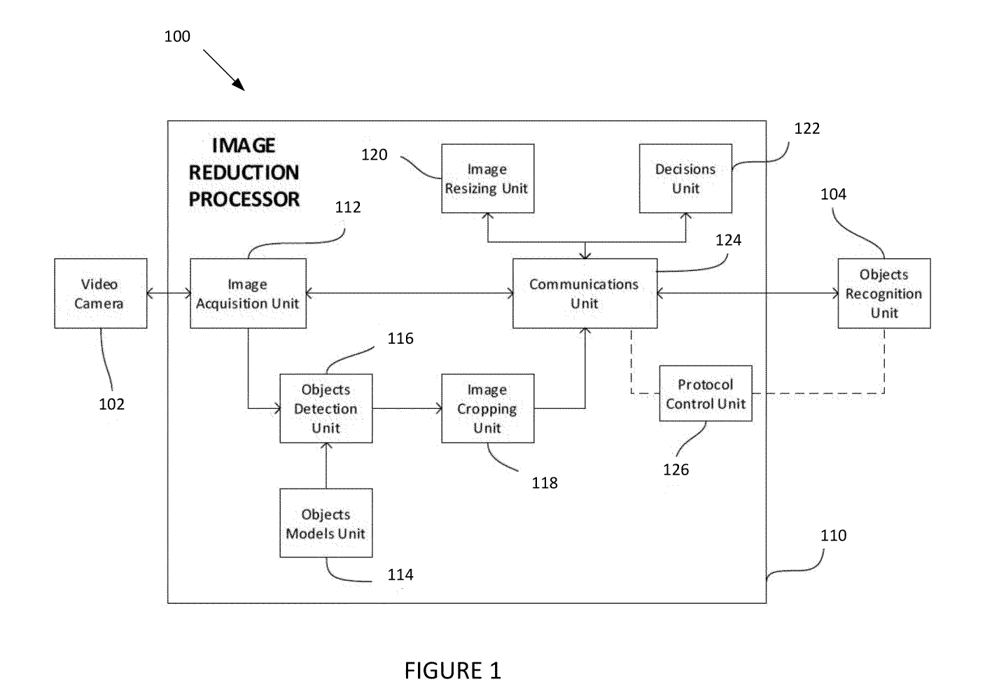

With reference first to FIG. 1, an embodiment of an exemplary image processing system 100 comprising video camera 102, objects recognition unit 104 and image reduction processor 110 is provided. FIG. 1 is a block diagram that schematically illustrates an image reduction processor 110 connected to a video camera 102 and an objects recognition unit 104. The image reduction processor 110 is equipped with: an image acquisition unit 112; an objects detection unit 116; an objects models unit 114 holding computer vision and machine learning for detecting predefined objects; an image cropping unit 118; a communications unit 124; a protocol control unit 126 to manage communication logic between reduction units and machine vision applications; an image resizing unit 120; a decisions unit 122 to resolve constraints on objects sizes. Furthermore the functions of FIG. 1 are computer-implementable.

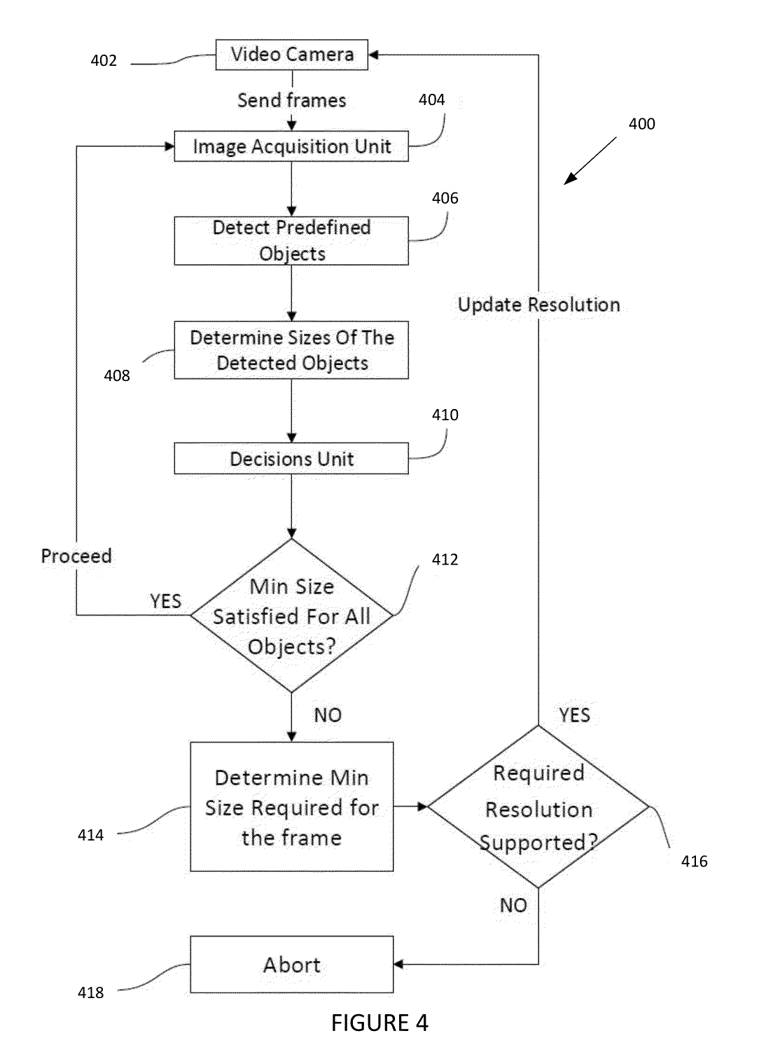

The video camera 102 captures videos or images at a defined frame rate (FPS) and fixed resolution, the objects recognition unit 104 requests to receive predefined objects and specifies the least accepted sizes. The image reduction processor 110 then retrieves frames using the image acquisition unit 112 and initializes the image reduction process which may result in updating the video camera 102 resolution in order to satisfy all constraints on objects sizes. The initialization process will be made clearer when describing the embodiments of FIG. 4.

After initializing the image reduction processor 110 to process an image frame retrieved from the video camera 102, the objects detection unit 116 detects if an object of interest that was requested by machine vision application is present in the frame. This is done using models stored in the objects models unit 114. If no objects are detected, the image acquisition unit 112 will proceed with the next frame. Otherwise, the coordinates of the smallest region containing the object are fed to the image cropping unit 118, which in turn crops the region producing a subimage. The subimage is sent to the communications unit 124 which will rely on the decisions unit 122 to check whether the current subimage needs to be further downsized, if so, the image resizing unit 120 will resize it to the determined target size. When the subimage is ready for transfer the communications unit 124 will proceed by sending it the objects detection unit 116.

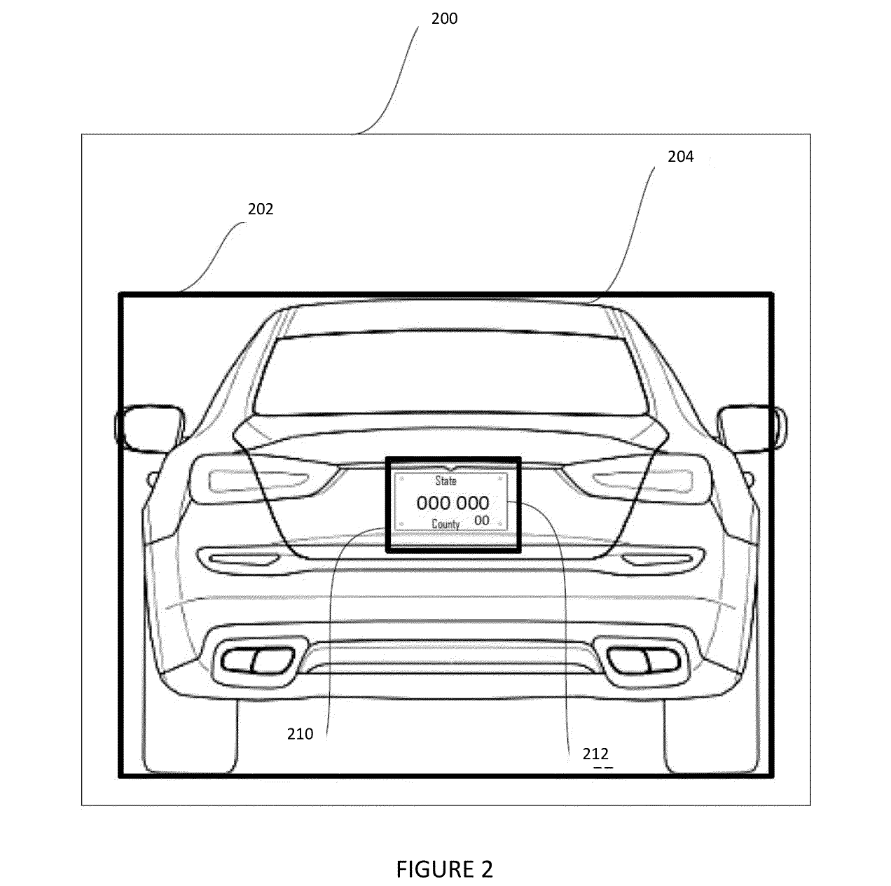

With reference now to FIG. 2, an embodiment of an example image subject to data reduction 200 and containing two objects of interest, a vehicle 204 and its license plate 212 according to the present invention is provided. When such image is fed to the objects detection unit 116, two regions of interest will be detected: a region 202 containing a vehicle 204, and a region 210 containing a license plate 212.

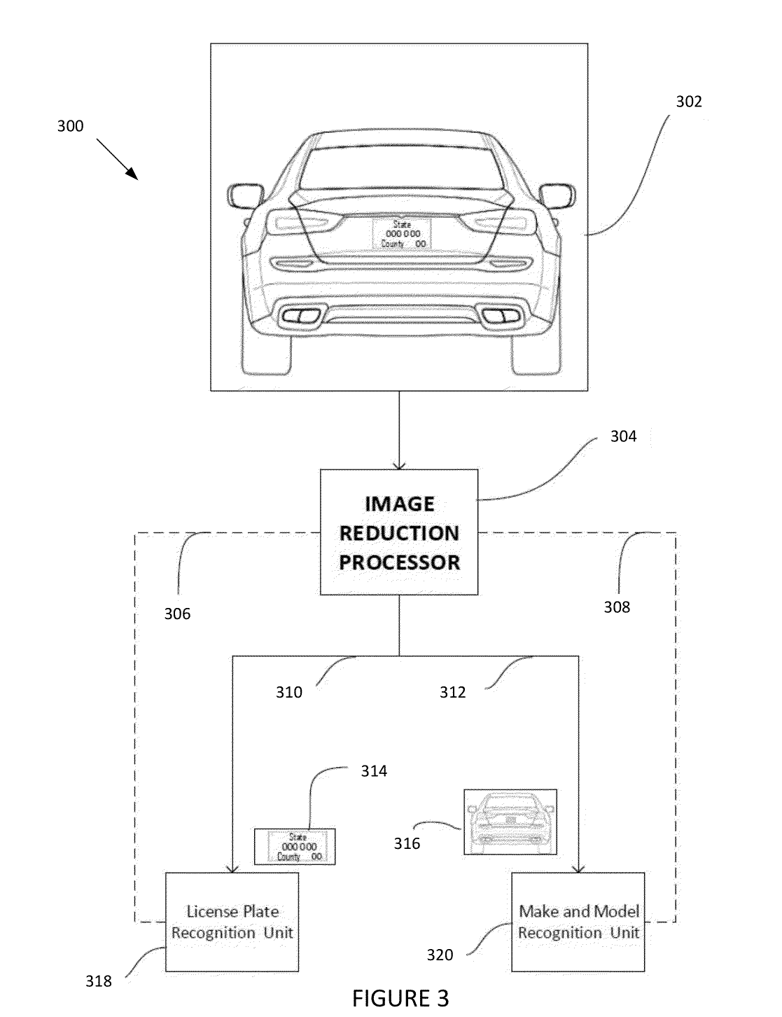

With reference now to FIG. 3, an embodiment of the process 300 for the processing of the example image of FIG. 2 by the image reduction processor 304 according to the present invention is provided. Two machine vision applications, license plate recognition unit 318 and make and model recognition unit 320, register requests to receive images of license plates and vehicles as well as the least accepted sizes. The requests are made through control links: control link 306 and control link 308. The recognition units are also connected to the image reduction processor 304 by means of data links: data link 310 and data link 312. The input image 302 is processed by the image reduction processor 304 and reduced to two subimages: a subimage consisting of the cropped and resized vehicle 316 and a subimage consisting of the cropped license plate 314. Thus, reducing the amount of data being transferred over the data links.

In one embodiment, the two machine vision applications, license plate recognition unit 318 and make and model recognition unit 320, are stored in a memory and executed by a processor in a remote computer connected to an image capturing device by means of a wired or wireless communication link. In this embodiment, the first application performs the recognition of an object, object1, and the second application recognizes object2. The image acquisition device is capable of detecting rectangular regions containing the objects in question. The minimum size required for object1 is MinSize1 and for object2 is MinSize2 (MinSize1 and MinSize2 are specified by the machine vision applications). The image acquisition device captures an image containing both object1 and object2, for the machine vision applications to produce the expected accuracy both objects need to have at least the minimum sizes MinSize1 and MinSize2. Thus, the captured image must comply with these two constraints, which will impose the image to have a minimum size to guaranty accuracy of recognition for the two applications. However, in some scenarios satisfying one of the constraint, say size(object1)≧MinSize1 may lead to the second constraints, size(object2)≧MinSize2, being satisfied automatically. In some situations, the second constraint might not only be satisfied, it may greatly exceed the size margin, making object2 very much larger than MinSize2 (i.e. size(object2)>>MinSize2).

The useful information contained within the image to be object1 and object2 may comprise significantly less than the entire image. To reduce the use of the communication line's bandwidth, the image acquisition device may crop the two objects and send them as two separate streams to the requesting parties (here the two machine vision applications). Doing so while respecting the constraints set in the previous paragraph will produce a cropped image of object1 having as size MinSize1, and a cropped image of object2 having as size, size(object2), which is larger than the minimum size required by the machine vision application (size(object2)>>MinSize2). This will lead to an over utilization of the communication link's bandwidth at no gain in information nor in accuracy. In order to overcome this, it is better to downsize the copped image of object2 to MinSize2 before sending it to the application. Thus, reducing the image data being transferred over the communication link and in the same time complying with all constraints imposed by the machine vision applications which is the intent of the invention.

With reference now to FIG. 4, a flowchart 400 describing the image reduction initialization process according to the present invention is provided. The purpose of the initialization is to set the optimal resolution for the video camera 402. The image acquisition unit 404 starts by retrieving frames from the video camera 402, then a function is executed to detect predefined objects at 406 and determine size of the detected objects at 408. The decisions unit 410 checks whether minimum sizes constraints are satisfied for all objects at 412. If all constraints are satisfied the system proceeds with image reduction process, otherwise, extra steps are executed to determine minimum size required for the camera frame at 414 and check whether the resolution required is supported by the video camera at 416. If the required resolution is supported the system instructs the video camera 402 to increase its frame resolution, otherwise, abort the image reduction process 418.

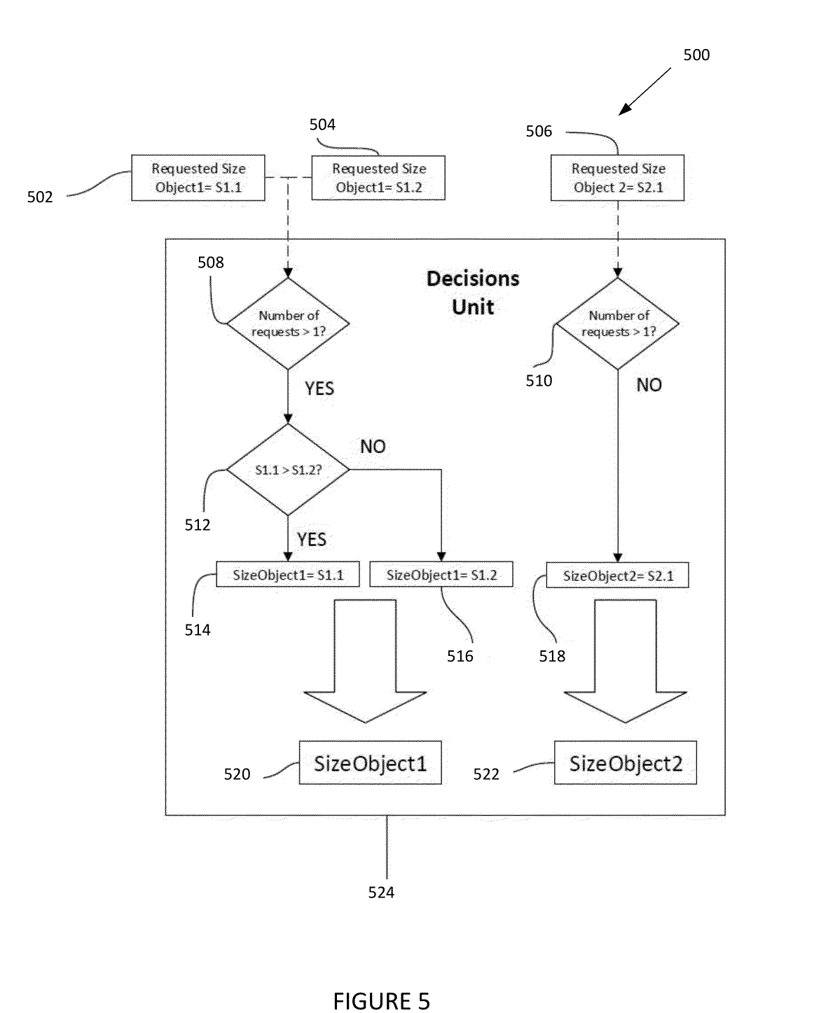

With reference now to FIG. 5, a flowchart 500 exemplifying resolution of constraints on object sizes according to the present invention is provided. It shows a decisions unit 524 having as inputs: a requested size for object1 by a machine vision application at 502, a requested size for object1 by a second machine vision application at 504, and a requested size for object2 by a machine vision application at 506. For object1 and object2 the decisions unit 524 starts by checking if there is more than one requested size at 508, 510. In this embodiment, object2 has only one requested size, thus, set sizeobject2=S2.1 at 518. Object1 was requested by two different applications and with two different sizes, 514 and 516, the system determine the maximum requested size at 512 as to satisfy all constraints. The final step is to store the determined target sizes for all the objects object1 520 and object2 522.

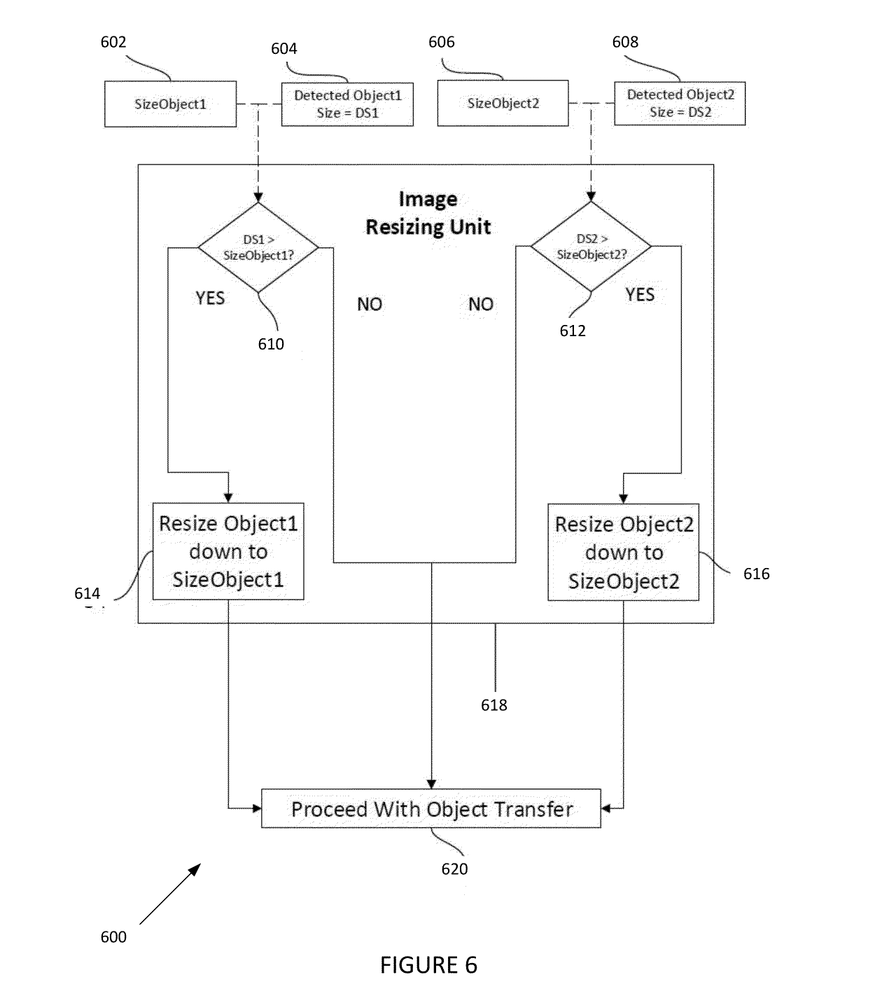

With reference now to FIG. 6, a flowchart 600 exemplifying objects resizing according to the present invention is provided. An image resizing unit 618 takes as inputs the subimages containing the objects detected (not illustrated in the flowchart), the target sizes for object1 602 and object2 606, and the detected sizes of objects 604 and 608. If the actual sizes are greater than the target sizes as shown at 610 and 612 the system resizes the subimages of objects down to the target sizes at 614 and 616 and then proceeds with object transfer at 620, otherwise, proceeds with object transfer 620 without resizing.

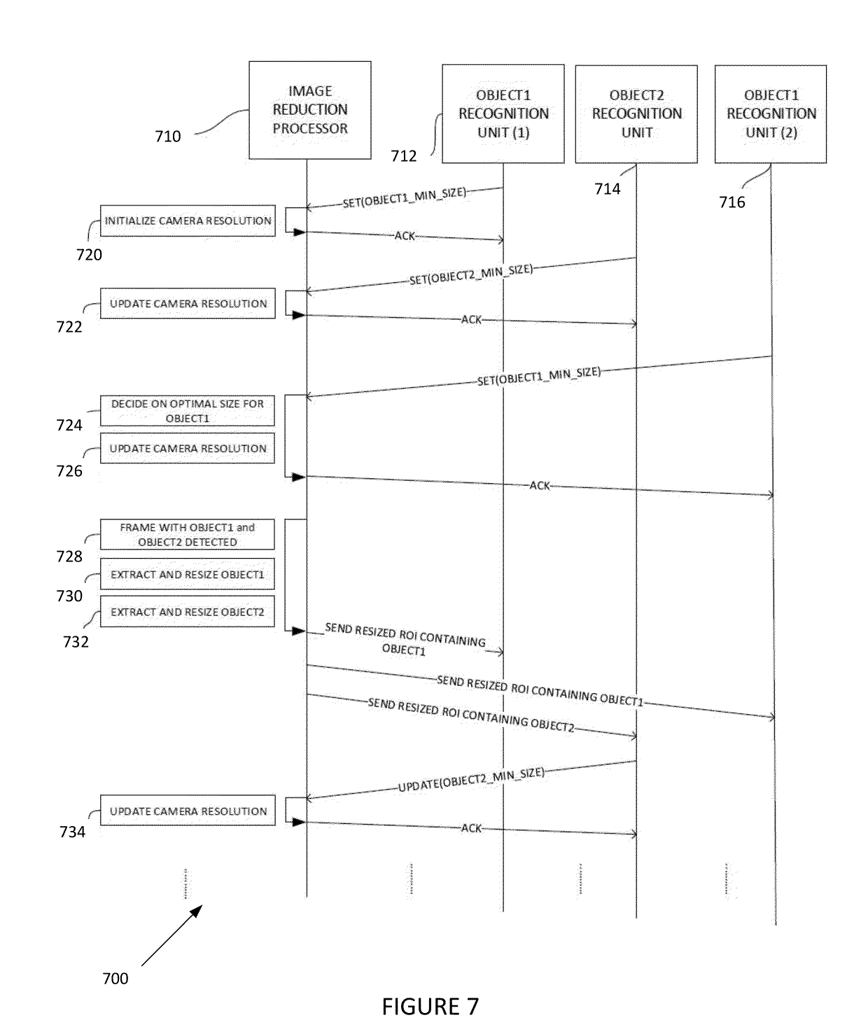

With reference now to FIG. 7, a sequence diagram 700 describing an exemplary execution of the protocol object according to the present invention is provided. The setup contains an image reduction processor 710 detailed in FIG. 1, two object1 recognition units 712 and 716, and a recognition unit for object2 714. In the illustrated scenario, each recognition unit starts by setting its least accepted size: SET(OBJECT1_M I N_SI Z E), SET(OBJ ECT2_MIN_SIZE), and SET(OBJECT1_MIN_SIZE). The first request results in the initialization process being executed 720, after then each new request will result on updating the camera resolution if needed at 722, 726, and 734. If conflicts between requests are detected a decision step will run to decide on the optimal sizes 724. Then, the system proceeds with image data reduction: 1) a frame containing object1 and object2 is detected at 728; 2) crop and resize region of interest containing object1 at 730; 3) crop and resize region of interest containing object2 at 732. The following step is to transfer the reduced data to requesting parties: SEND RESIZED ROI CONTAINING OBJECT1 SEND RESIZED ROI CONTAINING OBJECT2.

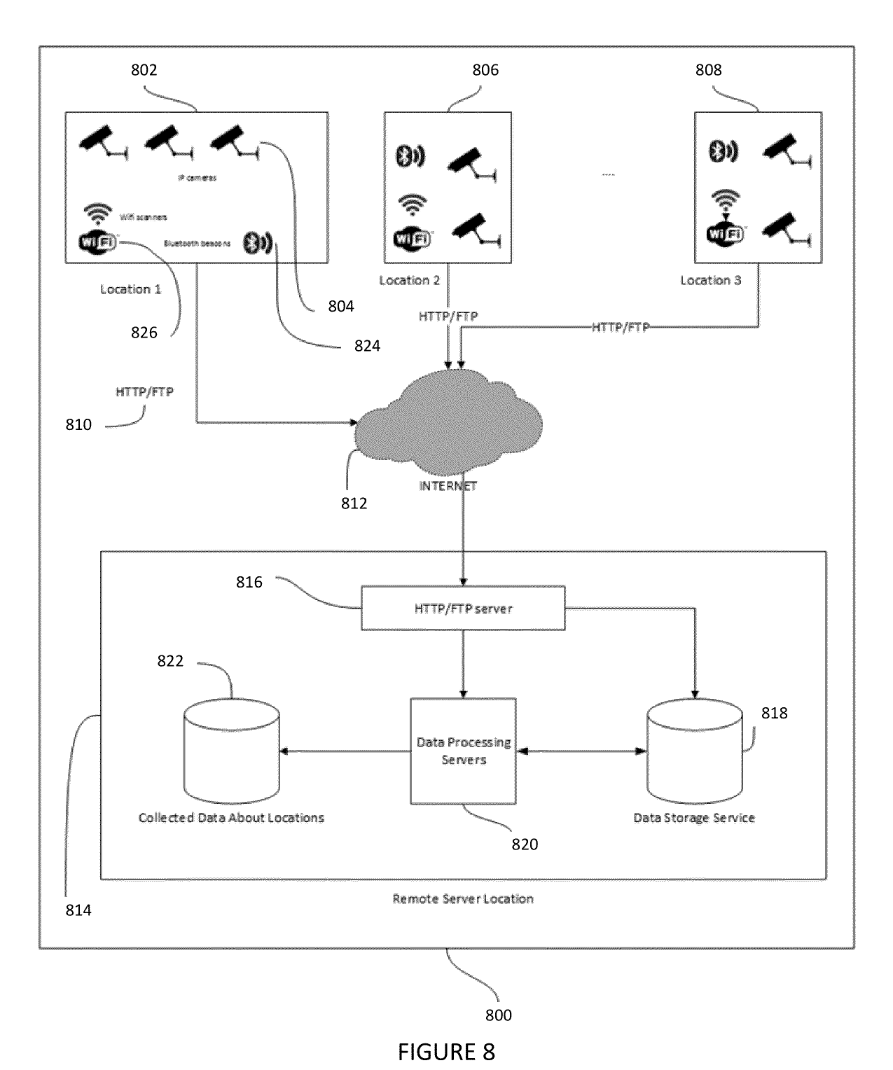

With reference now to FIG. 8, a block diagram of a preferred embodiment of the system 800 for the measurement, collection, and monitoring of vehicle traffic at a certain location in accordance with the present invention is provided. The system 800 may comprise separate data collection systems 802, 806, and 808. A data collection system such as system 802 may be a specific geographical location where cameras 804 have been emplaced to observe vehicle traffic. In this embodiment, data collection system 802 utilizes three cameras. Cameras utilized may include license plate reading cameras, still motion wildlife cameras, or any type of camera with high enough resolution to extract data needed. The specific cameras 804 may be used to capture a mixture of motion and still images and transmit that data to the Internet through various means including Wi-Fi, cellular transmission, and cable modem. The data collection system 802 may also include a Wi-Fi scanner 826 and Bluetooth beacons 824. The scanner 826 and beacons 824 may be used to locate and identify Wi-Fi and Bluetooth devices and networks operating in the range of the data collection system 802. This data may then be associated with any vehicle or individual customer identified by the data collection system 802 and added to a customer profile. In addition to using cameras 804, Wi-Fi scanners 823, and Bluetooth beacons 824, the data collection system 802 may further comprise global positioning system (GPS) devices adapted to collect geo-location data.

The data collection system 802 does not need to be permanently affixed at a physical location. The data collection system 802 may also be affixed to a mobile vehicle or to a trailer or may be hard carried. If the data collection system 802 is incorporated into a mobile platform, the data collection system 802 may be driven or moved through residential, industrial, or other areas away from a fixed business location. A mobile data collection system would enable data to be collected from areas near a business location and would also enable data to be collected for specific neighborhoods or sub-regions of a city, county, or state. Furthermore, by collecting geo-location data in addition to video and wireless network data, additional information granularity may be added to the gathered data. Furthermore, the data collection system 802 may collect additional empirical data in addition to video data. The data collection system 802 may collect data relating to traffic flows, time and duration of visits, locations visited, customer home and work addresses, and routes traveled by a vehicle. This empirical data may be utilized on its own or further processed to determine home or work addresses, type of tenancy (e.g., rent, own), size of house, price of home, price of rent, drive times to certain locations, commuting routes, shopping preferences, social and event preferences. By utilizing both empirical and inferred data the present invention provides a thorough picture of customer preferences and habits.

A set of HTTP/FTP protocol communication devices 810 may be used for data transmission. The Internet 112 may be any means of data transmission from one geographical point to another that provides the data collection systems 802, 806, and 808 to be in operative communication with the data processing system 814. The data processing system 814 encapsulates the data processing component of the data collection and analysis process. The system 800 may be configured to gather many types of data. The data gathered may be demographic data or may be volumetric data relating to traffic flow at a location.

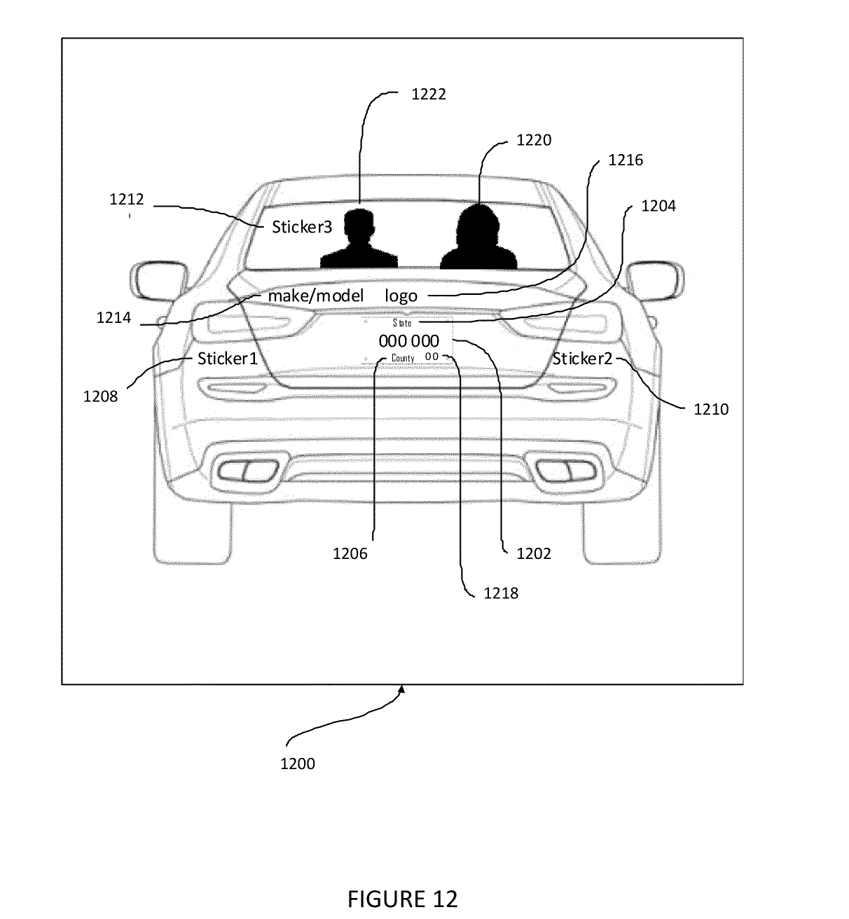

The HTTP/FTP server 816 sorts incoming data into two categories; immediate processing or data storage to wait for processing at a later time. The data storage services database 818 may comprise an object-key database (e.g. Amazon simple storage service S3) used as a data storage for both unprocessed and processed data that can consist of third party vendor services as well as facilities owned directly by the business. The data processing servers 820 may be business owned or may be provided third party vendor servers that convert the digital imagery of vehicles into data points (see FIG. 12). Personally identifiable information such as a license plate number is converted to a randomized identification number that is then assigned to that vehicle and used thereafter to identify it. The demographics and preferences of individuals database 822 may comprise data collected by the business from multiple sources that identifies such things as who drives what type of vehicle, what color preference says about someone, and what specific bumper stickers and license plate styles indicate about the vehicle owner.

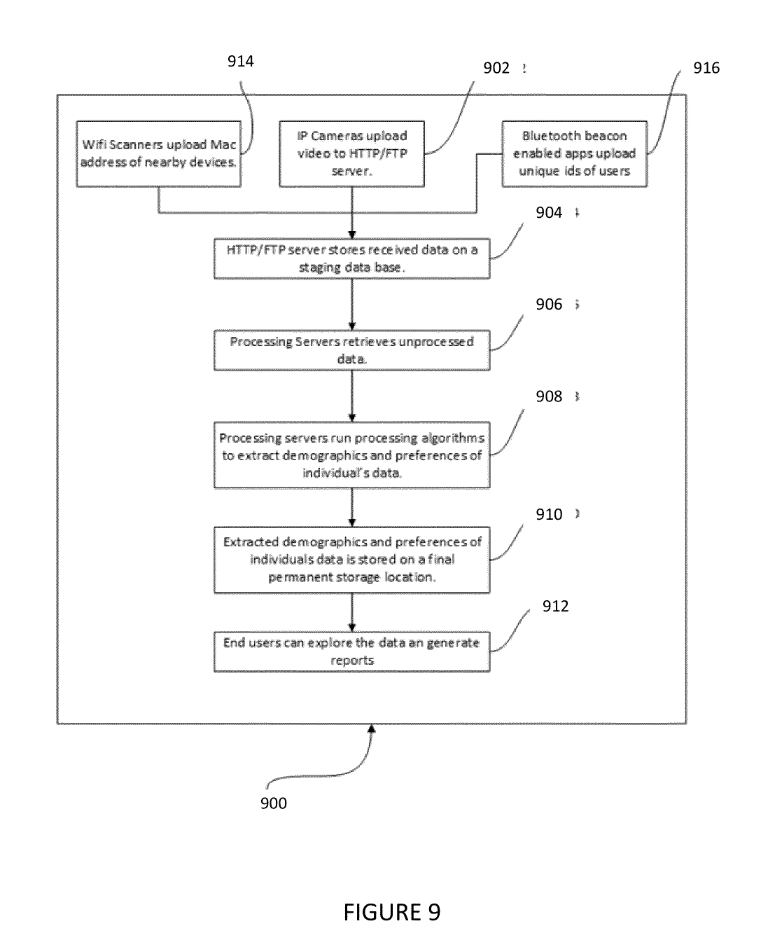

With reference now to FIG. 9, a flowchart 900 illustrates one embodiment of a step by step description of the process for collecting and analyzing demographics data from an image according to the present invention. First, at step 902 IP cameras upload video to HTTP/FTP server. The images uploaded at step 902 may have been compressed according to the methods described hereinabove with respect to FIGS. 1-7. Data including MAC addresses scanned by Wi-Fi scanners at 914 and Bluetooth beacon IDs and additional Bluetooth network data at 916 may also be uploaded. Additionally, data from other sources may supplement data collected at 902, 914, and 916. The supplemental data may be empirical data, data collected from external sources, or manually input data. An HTTP/FTP server stores received data on a staging database at 904. The, at 906 one or more processing servers retrieve unprocessed data. At 908 the one or more processing servers run video processing algorithms to extract demographics and preferences of individual's data from the images uploaded at 902. The data processed at 908 may be raw data, or it may be data that had been compressed prior to the upload at step 902 and decompressed prior to the analysis in step 908. The compression and decompression may be performed according to the methods described hereinabove with respect to FIGS. 1-7. In step 910 extracted demographics and preferences of individual's data are stored in a final permanent storage location such as a database. After storage of the data, at 912 end users may explore the data and generate reports through multiple means to include the use of the business Digital Dashboard Application or via Application Programming Interface (API) that customers can use to ingest data from system and method into their own existing data systems.

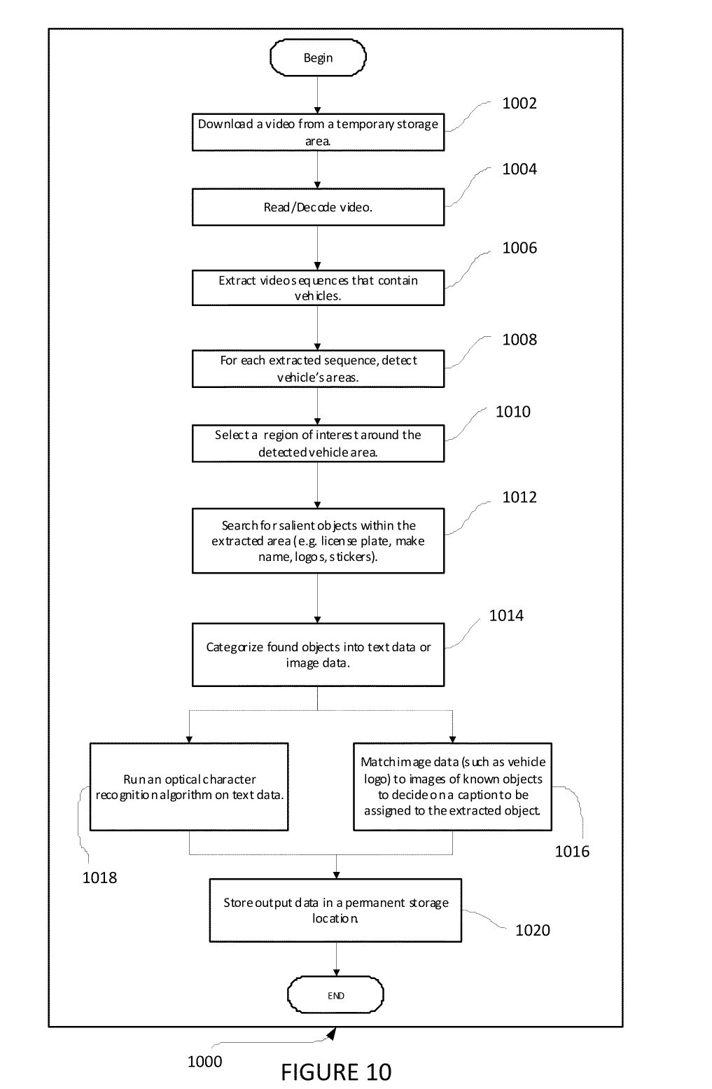

With reference now to FIG. 10, a detailed flowchart 1000 showing an embodiment of the process for collecting and analyzing demographics data from an image according to the present invention is provided. In this embodiment, the system first receives or downloads video or images to be processed at 1002 from a temporary storage area that may be a database or temporary storage memory. At step 1004 the system reads and decodes video. The system then extracts video sequences that contain vehicles at 1006. After extracting the sequences containing vehicles, the system then detects and classifies different areas of vehicle in extracted images at 1008. The extracted and detected areas are then further processed to select a region of interest around the detected vehicle area at 1010. At step 1012 the system then searches for salient objects within the extracted area (e.g., license plate, make name, logos, stickers, etc.). Any salient objects found in 1012 are then categorized into text data or image data at 1014. The system at 1016 matches image data (such as vehicle logo) to images of known objects to decide on a caption to be assigned to the extracted object. At 1018 an optical character recognition algorithm is then run on text data matched in the previous step. Finally, at 1020 the system stores output data in a permanent storage location which may be a customer database.

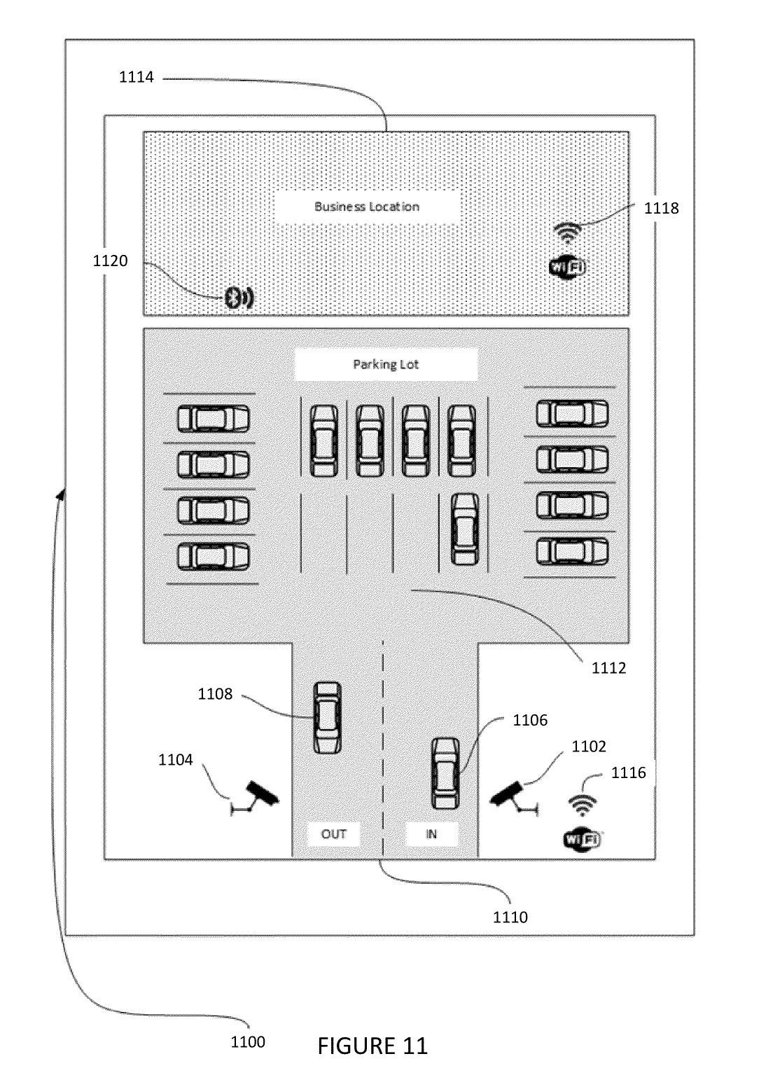

With reference now to FIG. 11, an example diagram of a data collection site 1100 according to the present invention is provided. A camera may be positioned at camera location 1102 at the entrance of a parking lot to capture images of entering vehicle traffic 1106 as it enters the business location 1114. An additional camera may be positioned at camera location 1104 at the exit of a parking lot to capture images of exiting vehicle traffic 1108 as it departs the business location 1114. The cameras do not need to be permanently secured at the business location 1114. In one embodiment, mobile cameras or trailer mounted cameras may be implemented. The mobile cameras may be affixed to a vehicle and moved through the parking lot 1112 or near or around the business location 1114. The mobile camera may be scheduled to gather data at the business location at regular intervals. Additionally, a trailer containing one or more cameras or other data gather equipment may be placed at the business location 1114. The trailer may be placed at the business location 1114 on a temporary basis. The use of a mobile camera or a trailer mounted camera reduces the cost and invasiveness of the data gathering system. Using a mobile camera or trailer mounted camera allows a business owner to have data gathered at a business location without installing cameras, wired or wireless data networks, or other on-site hardware. The cameras may be supplemented by wireless network data gathering devices including Wi-Fi scanners 1116 and 1118. A marker 1110 dividing area for entering and exiting vehicles may be used to assist the system in differentiating between vehicles entering and exiting the parking lot 1112.

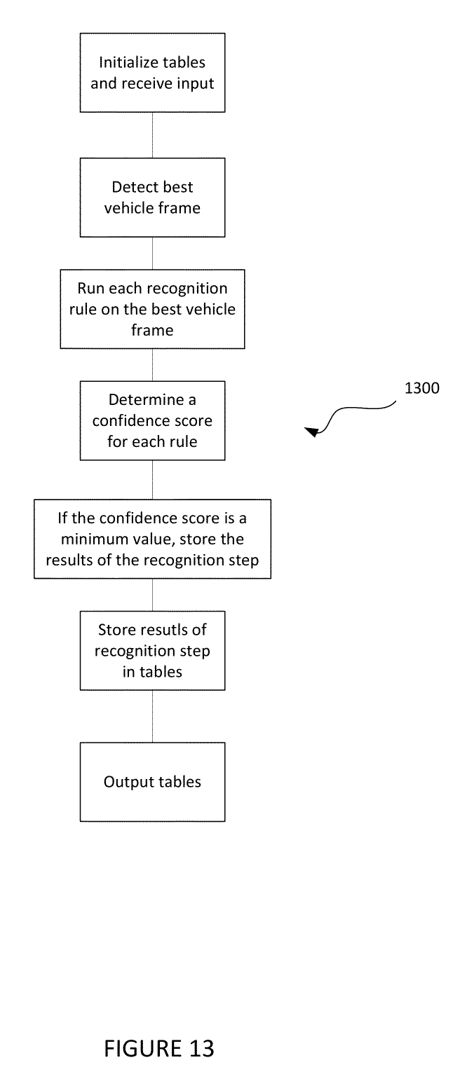

With reference now to FIG. 12, a diagram depicts the data that may be extracted from a vehicle image 1200 by an embodiment of the process for collecting and analyzing demographics data from an image according to the present invention. Data that may be extracted from the vehicle image 1200 may include: the license plate number of the vehicle 1202; the state of origin 1204 of the license plate 1202; the county of origin 1206 of the license plate 1202; a set of one or more bumper stickers which may include bumper stickers 1208, 1210, and 1212; data points 1214 on the vehicle including emblem and name that may denote the vehicles make, model, and year of manufacture; logos 1215 that may include logos from manufacturers, owners, and car dealerships; a registration date 1218 on the license plate 1202; a driver 1220; and one or more passengers 1222. The data collected from the vehicle image 1200 by the system 1100 according to the method 1000 described hereinabove with be further processed according the algorithm 1300 provided in FIG. 13.

With reference now to FIG. 13, an expression of the algorithm 1300 (Algorithm1) used to process vehicle images into data is provided. Using the system and method of the present invention as described above, vehicle make, model, year, color, license, and added vehicle information can be determined, which then allows for a determination of the consumer demographic and preferential information using mathematical algorithms combined with demographic and preferential database. The following example illustrates the application of the algorithm 1300 shown in FIG. 13 to a set of data that may be collected by the present invention.

In the following exemplary embodiment of the application of the algorithm 1300 to a set of example data, Tₙ refers to different phases of execution of the system at times T₀ . . . T₉ respectively. The data inputs and outputs and the algorithm are shown in Tables 1 and 2 below.

TABLE 1

| Algorithm 1 | Inferences of Demographics and Preferences of Individuals |
|---|---|
| Inputs: | Q, a FIFO (first in first out) queue holding video data of |
| | vehicles. |
| | R, a set of rules defining associations between vehicles and |
| | demographic information. |
| | VehicleSearch, a routine that takes a video sequence as an |
| | input and returns the best frame that contains a vehicle |
| | image. |
| | LicensePlateNumber, a routine that takes a vehicle image |
| | as an input and returns the plate number. |
| | RegistrationInfo, a routine that takes a vehicle image as an |
| | input and returns the registration information. |
| | VehicleInfo, a routine that takes a vehicle image as an |
| | input and returns the make, model, year, and color of the |
| | vehicle. |
| | BumperStickers, a routine that takes a vehicle image as an |
| | input and returns a text description of the bumper stickers. |
| | Encrypt, a routine that takes a set of characters as an input |
| | and returns an encrypted text. |
| | Match, a routine that takes a rule and Vehicle information |
| | as an input and returns a confidence value of the degree of |
| | matching between both inputs. |
| Outputs: | V, a data structure with vehicle information. |
| | D, a data structure with extracted demographics and |
| | preferences information. |

TABLE 2
Algorithm 1

```
1)  Initilize V and D
2)  repeat
3)  Current Event ← Q.dequeue( )
4)  BestVehicleFrame ← VehicleSearch(CurrentEvent)
5)  Number ← LicensePlateNumber(BestVehicleFrame)
6)  [State, County, BirthMonth] ←
        RegistrationInfo(BestVehicleFrame)
7)  [Make, Model, Year, Color] ← VehicleInfo(BestVehicleFrame)
8)  Preferences ← BumperStickers(BestVehicleFrame)
9)  EncryptedPlateNumber ← Encrypt(BestVehicleFrame)
10)  CurrentVehicle ← [Timestamp, EncryptedPlateNumber, State,
        County, BirthMonth, Make, Model, Year, Color, Preferences]
11)  MaxConfidence ←0
12)  BestRuleIndex ← 0
13)  tempConfidence ← 0
14)  for i ← 1 to R.length( ) do
15)  tempConfidence ← Match (R(i), CurrentVehicle)
16)  if tempConfidence > MaxConfidence then
17)  MaxConfidence ← tempConfidence
18)  BestRuleIndex ← i
19)  end if
20)  end for
21)  if MaxConfidence > 0 then
22)  BestRule ← R(BestRuleIndex)
23)  [LocalePreference, IncomeLevel, FamilySize, Profession,
            Eco-Friendly, EducationLevel, Age, Gender] ←
            BestRule.getData( )
24)  CurrentDemographics ← [CurrentVehicle.TimeStamp,
            EncryptedPlateNumber, State, County, BirthMonth,
            Preferences, LocalePreference, IncomeLevel, FamilySize,
            Profession, Eco-Friendly, EducationLevel, Age, Gender,
            MaxConfidence]
25)  V.add(CurrentVehicle)
26)  D.add(CurrentDemographics)
27)  end if
28) until Q is empty
29) return V, D
```

At T₀: Let R be the set of rules defined in the algorithm 1300 (Algorithm1) shown in FIG. 13, and each set of data x contained in the data sets R(n)={x} be a set of data collected by the system and method of the present invention:

R(1)={Ford, [F150, F250], Kentucky, [Black], 1999-2012}→{Male, Age: 40-80, Locale Preference Suburban, Income Level: 40,000-60,000, Family Size: Large, Profession: Part-Time, Eco-Friendly: No, Education Level: Some College}

R(2)={Dodge, Challenger, New Jersey, Red, 2010-2014}→{Male, Age: <40, Locale Preference Urban, Income Level: >60,000, Family Size: Small, Profession: Part-Time, Eco-Friendly: No, Education Level: Bachelors}

R(3)={Lexus, Kentucky, [Silver, Black]}→{Male, Age: 40-70, Locale Preference: Urban, Income Level: >100,000, Family Size: Large, Profession: White Collar, Eco-Friendly: No, Education Level: Bachelors}

R(4)={Volkswagen, Beetle, Kentucky, [White, Yellow]}→{Female, Age: 20-35, Locale Preference Urban, Income Level: <60,000, Family Size: Small, Profession: Homemaker, Eco-Friendly: Yes, Education Level: Some College}

R(5)={Hyundai, Elantra, California, [Red, Blue]}→{Female, Age: 30-50, Locale Preference: Urban, Income Level: >40,000, Family Size: Large, Profession: Homemaker, Eco-Friendly: Yes, Education Level: Bachelors}

R(6)={Chevrolet, HHR, Kentucky, [White, Blue]}→{Female, Age: 20-40, Locale Preference: Urban, Income Level: 40,000-60,000, Family Size: Small, Profession: Part-Time, Eco-Friendly: Yes, Education Level: Some College}

At T₁: Cameras located at different locations upload video sequences of vehicles detected based on motion.

At T₂: Received video sequences are added to Q, the queue defined in Algorithm1, for example suppose four video sequences are uploaded:

Video Sequence 1 (R(1)): A video of a 2004 White Ford F150 with: plate number: ABC123; State: Kentucky; County: Jefferson; BirthMonth: 4; and Bumper Stickers: No.

Video Sequence 2 (R(2)): A video of a 2012 Silver Lexus es350 with: plate number: DEF456; State: Kentucky; County: Jefferson; BirthMonth: 12; and Bumper Stickers: {Breast cancer awareness, Veteran}.

Video Sequence 3 (R(3)): A video of a 2005 Blue Hyundai Elantra with: plate number: GHI789; State: Kentucky; County: Oldham; BirthMonth: 7; and Bumper Stickers: {Breast cancer awareness, Sports fan, Obama Biden 2012}.

Video Sequence 4 (R(4)): A video of a 2002 Yellow Volkswagen Beetle with: plate number: JKL012; State: Kentucky; County: Oldham; BirthMonth: 3; and Bumper Stickers: {Breast cancer awareness}

At T₃: Run Algorithm1.

Partial outputs of Algorithm) on Sequence 1:

Step 4: Best frame that contains the vehicle

Step 5: ABC 123

Step 6: [Kentucky, Jefferson, 4]

Step 7: [Ford, F150, 2004, White]

Step 8: [ ]

Step 9: At #$%̂&

Step 10: CurrentVehicle=[2013-9-17-09:31:00, At #$%̂&, Kentucky, Jefferson, 4, Ford, F150, 2004, White]

Step 14: i=1 (Match data from step10 to Rule 1)

Step 15: tempConfidence=90%

Step 17: MaxConfidence=90%

Step 18: BestRuleIndex=1

Step 14: i=2 (Match data from step10 to Rule 2)

Step 15: tempConfidence=0%

Step 17: MaxConfidence=90%

Step 18: BestRuleIndex=1

Step 14: i=3 (Match data from step10 to Rule 3)

Step 15: tempConfidence=10%

Step 17: MaxConfidence=90%

Step 18: BestRuleIndex=1

Step 14: i=4 (Match data from step10 to Rule 4)

Step 15: tempConfidence=20%

Step 17: MaxConfidence=90%

Step 18: BestRuleIndex=1

Step 14: i=5 (Match data from step10 to Rule 5)

Step 15: tempConfidence=0%

Step 17: MaxConfidence=90%

Step 18: BestRuleIndex=1

Step 14: i=6 (Match data from step10 to Rule 6)

Step 15: tempConfidence=2 0%

Step 17: MaxConfidence=90%

Step 18: BestRuleIndex=1

Step 22: {Ford, [F150, F250], Kentucky, [Black], 1999-2012}→{Male, Age: 40-80, Locale Preference Suburban, Income Level: 40,000-60,000, Family Size: Large, Profession: Part-Time, Eco-Friendly: No, Education Level: Some College}

Step 23: [Suburban, 40,000-60,000, Large, Part-Time, No, Some College, 40-80, Male]

Step 24: CurrentDemographics=[2013-9-17-09:31:00, At #$%̂&, Kentucky, Jefferson, 4, Suburban, 40,000-60,000, Large, Part-Time, No, Some College, 40-80, Male, 90%]

Step 25: V={[2013-9-17-09:31:00, At #$%̂&, Kentucky, Jefferson, 4, Suburban, 40,000-60,000, Large, Part-Time, No, Some College, 40-80, Male, 90%]}

Step 26: D={[2013-9-17-09:31:00, At #$%̂&, Kentucky, Jefferson, 4, Ford, F150, 2004, White]}

At T₅: Q is not empty continue with Sequence 2

Partial outputs of Algorithm1 on Sequence 2:

Step 4: Best frame that contains the vehicle

Step 5: DEF456

Step 6: [Kentucky, Jefferson, 12]

Step 7: [Lexus, es350, 2012, Silver]

Step 8: [Breast cancer awareness, Veteran]

Step 9: $#At %̂*

Step 10: CurrentVehicle=[2013-9-17-09:32:00, $#At %̂*, Kentucky, Jefferson, 12, Lexus, es350, 2012, Silver, [Breast cancer awareness, Veteran]]

Step 14 through Step 19: MaxConfidence=80%, BestRuleIndex=3

Step 22: {Lexus, Kentucky, [Silver, Black]}→{Male, Age: 40-70, Locale Preference: Urban, Income Level: >100,000, Family Size: Large, Profession: White Collar, Eco-Friendly: No, Education Level: Bachelors}

Step 23: [Urban,>100,000, Large, White Collar, No, Bachelors, 40-70, Male]

Step 24: CurrentDemographics=[2013-9-17-09:32:00, $#At %̂*, Kentucky, Jefferson, 12, [Breast cancer awareness, Veteran], Urban,>100,000, Large, White Collar, No, Bachelors, 40-70, Male, 80%]

Step 25: V={[2013-9-17-09:31:00, At #$%̂&, Kentucky, Jefferson, 4, Ford, F150, 2004, White], [2013-9-17-09:32:00, $#At % A*, Kentucky, Jefferson, 12, Lexus, es350, 2012, Silver, [Breast cancer awareness, Veteran]]}

Step 26: D={[2013-9-17-09:31:00, At #$%̂&, Kentucky, Jefferson, 4, Suburban, 40,000-60,000, Large, Part-Time, No, Some College, 40-80, Male, 90%],[2013-9-17-09:32:00, $#At %̂*, Kentucky, Jefferson, 12, [Breast cancer awareness, Veteran], Urban,>100,000, Large, White Collar, No, Bachelors, 40-70, Male, 80%]}

At T₆: Q is not empty continue with Sequence 3

Partial outputs of Algorithm) on Sequence 3:

Step 4: Best frame that contains the vehicle

Step 5: GHI789

Step 6: [Kentucky, Oldham, 7]

Step 7: [Hyundai, Elantra, 2005, Blue]

Step 8: [Breast cancer awareness, Sports fan, Obama Biden 2012]

Step 9: #$% At̂*

Step 10: CurrentVehicle=[2013-9-17-09:33:00, #$% At̂*, Kentucky, Oldham, 7, Hyundai, Elantra, 2005, Blue, [Breast cancer awareness, Sports fan, Obama Biden 2012]]

Step 14 through Step 19: MaxConfidence=85%, BestRuleIndex=5

Step 22: {Hyundai, Elantra, California, [Red, Blue]}->{Female, Age: 30-50, Locale Preference Urban, Income Level: >40,000, Family Size: Large, Profession: Homemaker, Eco-Friendly: Yes, Education Level: Bachelors}

Step 23: [Urban,>40,000, Large, Homemaker, Yes, Bachelors, 30-50, Female]

Step 24: CurrentDemographics=[2013-9-17-09:33:00, #$% At̂*, Kentucky, Oldham, 7, [Breast cancer awareness, Sports fan, Obama Biden 2012], Urban,>40,000, Large, Homemaker, Yes, Bachelors, 30-50, Female, 85%]

Step 25: V={[2013-9-17-09:31:00, At #$%̂&, Kentucky, Jefferson, 4, Ford, F150, 2004, White], [2013-9-17-09:32:00, $#At %̂*, Kentucky, Jefferson, 12, Lexus, es350, 2012, Silver, [Breast cancer awareness, Veteran]], [2013-9-17-09:33:00, #$% At̂*, Kentucky, Oldham, 7, Hyundai, Elantra, 2005, Blue, [Breast cancer awareness, Sports fan, Obama Biden 2012]]}

Step 26: D={[2013-9-17-09:31:00, At #$%̂&, Kentucky, Jefferson, 4, Suburban, 40,000-60,000, Large, Part-Time, No, Some College, 40-80, Male, 90%],[2013-9-17-09:32:00, $#At %̂*, Kentucky, Jefferson, 12, [Breast cancer awareness, Veteran], Urban,>100,000, Large, White Collar, No, Bachelors, 40-70, Male, 80%],[2013-9-17-09:33:00, #$% At̂*, Kentucky, Oldham, 7, [Breast cancer awareness, Sports fan, Obama Biden 2012], Urban,>40,000, Large, Homemaker, Yes, Bachelors, 30-50, Female, 85%]}

At T₇: Q is not empty continue with Sequence 4

Partial outputs of Algorithm) on Sequence 4:

Step 4: Best frame that contains the vehicle

Step 5: JKL012

Step 6: [Kentucky, Oldham, 3]

Step 7: [Volkswagen, Beetle, 2002, Yellow]

Step 8: [Breast cancer awareness]

Step 9: $#%-̂*

Step 10: CurrentVehicle=[2013-9-17-09:34:00, $#%-̂*, Kentucky, Oldham, 3, Volkswagen, Beetle, 2002, Yellow, [Breast cancer awareness]]

Step 14 through Step 19: MaxConfidence=95%, BestRuleIndex=4

Step 22: {Volkswagen, Beetle, Kentucky, [White, Yellow]}→{Female, Age: 20-35, Locale Preference: Urban, Income Level: <60,000, Family Size: Small, Profession: Homemaker, Eco-Friendly: Yes, Education Level: Some College}

Step 23: [Urban,<60,000, Small, Homemaker, Yes, Some College, 20-35, Female]

Step 24: CurrentDemographics=[2013-9-17-09:34:00, $#%-̂*, Kentucky, Oldham, 7, [Breast cancer awareness], Urban,<60,000, Small, Homemaker, Yes, Some College, 20-35, Female, 95%]

Step 25: V={[2013-9-17-09:31:00, At #$%̂&, Kentucky, Jefferson, 4, Ford, F150, 2004, White], [2013-9-17-09:32:00, $#At %̂*, Kentucky, Jefferson, 12, Lexus, es350, 2012, Silver, [Breast cancer awareness, Veteran]],[2013-9-17-09:33:00, #$% At̂*, Kentucky, Oldham, 7, Hyundai, Elantra, 2005, Blue, [Breast cancer awareness, Sports fan, Obama Biden 2012]],[2013-9-17-09:34:00, $#%-̂*, Kentucky, Oldham, 3, Volkswagen, Beetle, 2002, Yellow, [Breast cancer awareness]]}

Step 26: D={[2013-9-17-09:31:00, At #$%̂&, Kentucky, Jefferson, 4, Suburban, 40,000-60,000, Large, Part-Time, No, Some College, 40-80, Male, 90%],[2013-9-17-09:32:00, $#At %̂*, Kentucky, Jefferson, 12, [Breast cancer awareness, Veteran], Urban,>100,000, Large, White Collar, No, Bachelors, 40-70, Male, 80%],[2013-9-17-09:33:00, #$% At̂*, #$% At ̂*, Kentucky, Oldham, 7, [Breast cancer awareness, Sports fan, Obama Biden 2012], Urban,>40,000, Large, Homemaker, Yes, Bachelors, 30-50, Female, 85%],[2013-9-17-09:34:00, $#%-̂*, Kentucky, Oldham, 7, [Breast cancer awareness], Urban, <60,000, Small, Homemaker, Yes, Some College, 20-35, Female, 95%]}

At T₈: Q is empty, return V and D

V=

TABLE 3

| | Encrypted | | | | | | | | |
|---|---|---|---|---|---|---|---|---|---|
| | Plate | | | Birth | | | | | |
| Timestamp | Number | State | County | Month | Make | Model | Year | Color | Preferences |
| 2013-9-17- | At #$%\hat{ }& | Kentucky | Jefferson | 4 | Ford | F150 | 2004 | White | — |
| 09:31:00 | | | | | | | | | |
| 2013-9-17- | $# At% \hat{ }* | Kentucky | Jefferson | 12 | Lexus | Es350 | 2012 | Sliver | Breast cancer |
| 09:32:00 | | | | | | | | | awareness, |
| | | | | | | | | | Veteran |
| 2013-9-17- | #$% At \hat{ }* | Kentucky | Oldham | 7 | Hyundai | Elantra | 2005 | Blue | Breast cancer |
| 09:33:00 | | | | | | | | | awareness, |
| | | | | | | | | | Sports fan, |
| | | | | | | | | | Obama Biden |
| | | | | | | | | | 2012 |
| 2013-9-17- | $#%-\hat{ }* | Kentucky | Oldham | 3 | Volks- | Beetle | 2002 | Yellow | Breast cancer |
| 09:34:00 | | | | | wagen | | | | awareness |

D=

TABLE 4

| | Encrypted | | | Birth | | | |
|---|---|---|---|---|---|---|---|
| Timestamp | Plate Number | State | County | Month | Preferences | Locale | Income |
| 2013-9- | At | Kentucky | Jefferson | 4 | — | Suburban | 40k-60k |
| 17-09:31:00 | #$%\hat{ }& | | | | | | |
| 2013-9- | $#At%\hat{ }* | Kentucky | Jefferson | 12 | Breast | Urban | >100k |
| 17-09:32:00 | | | | | cancer | | |
| | | | | | awareness, | | |
| | | | | | Veteran | | |
| 2013-9- | #$% At \hat{ }* | Kentucky | Oldham | 7 | Breast | Urban | >40k |
| 17-09:33:00 | | | | | cancer | | |
| | | | | | awareness, | | |
| | | | | | Sports fan, | | |
| | | | | | Obama | | |
| | | | | | Biden 2012 | | |
| 2013-9- | $#%-\hat{ }* | Kentucky | Oldham | 3 | Breast | Urban | <60k |
| 17-09:34:00 | | | | | cancer | | |
| | | | | | awareness | | |

| | | | Eco | Education | | | |
|---|---|---|---|---|---|---|---|
| Timestamp | Family | Profession | Friendly | Level | Age | gender | Confidence |
| 2013-9- | Large | Part Time | No | Some | 40-80 | Male | 90% |
| 17-09:31:00 | | | | College | | | |
| 2013-9- | Large | White | No | Bachelors | 40-70 | Male | 80% |
| 17-09:32:00 | | Collar | | | | | |
| 2013-9- | Large | Homemaker | Yes | Bachelors | 30-50 | Female | 85% |
| 17-09:33:00 | | | | | | | |
| 2013-9- | Small | Homemaker | Yes | Some | 20-35 | Female | 95% |
| 17-09:34:00 | | | | College | | | |

At T9: Store V and D in the database.

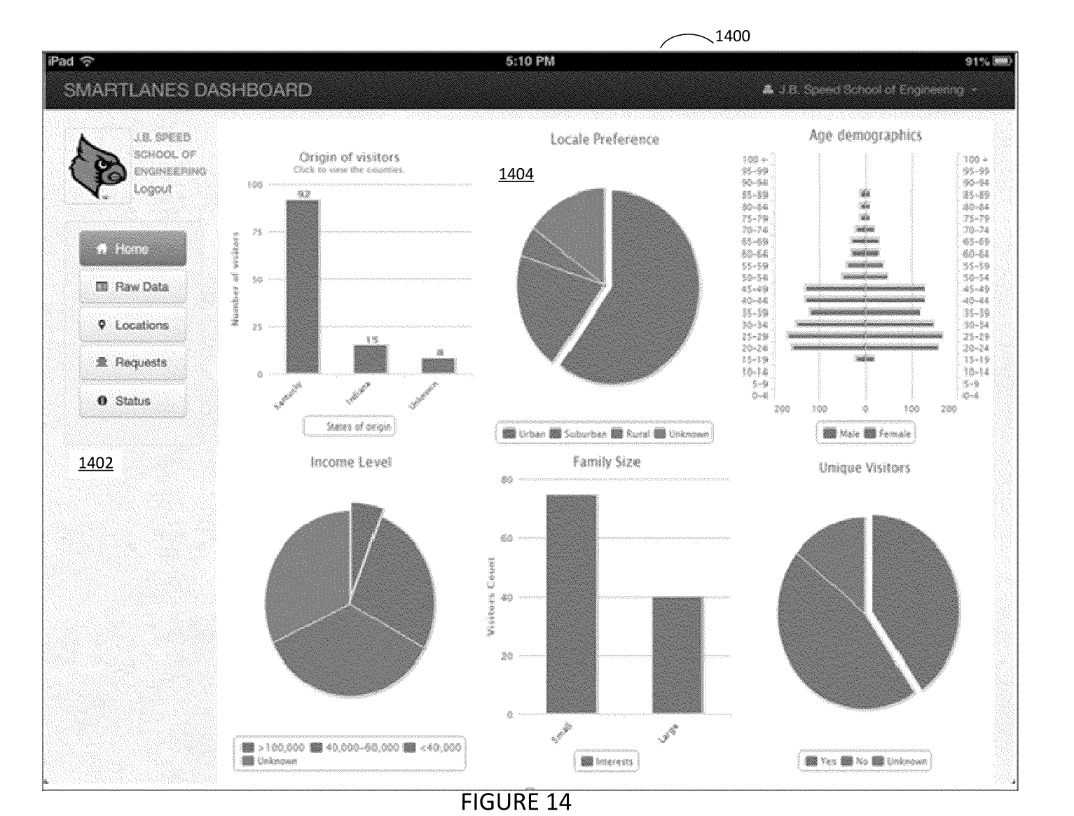

The data collected and processed by the system and stored as shown in the above example may be accessed and used by customers through reports, a data dashboard, or other user interface. Exemplary screenshots of a user interface and data dashboard are shown in FIGS. 14-23.

With reference now to FIG. 14, a screenshot 1400 of an exemplary embodiment of the invention is provided that shows the digital dashboard application that is used to display demographic information collected on a time series basis to customers of business process. Demographic information provided includes but is not limited to: time and date of visit; number of visits to site; length of stay at site; income level; state and county of origin; personality and preferences; preferred color; hobbies; purchasing habits; sports team affiliation; political beliefs and affiliations; family size; alma mater; and education level. The dashboard may include a set of options 1402 used to navigate to different areas of the dashboard including: the dashboard home; raw data screen; locations information; requests; and status screen. The dashboard home screen 1404 illustrates various graphs that may be used to display quantified data collected and processed from the raw video input data collected by the monitoring systems on site. The data on the home screen 1404 may be displayed as any number of charts, graphs, tables, infographs, or data clusters.

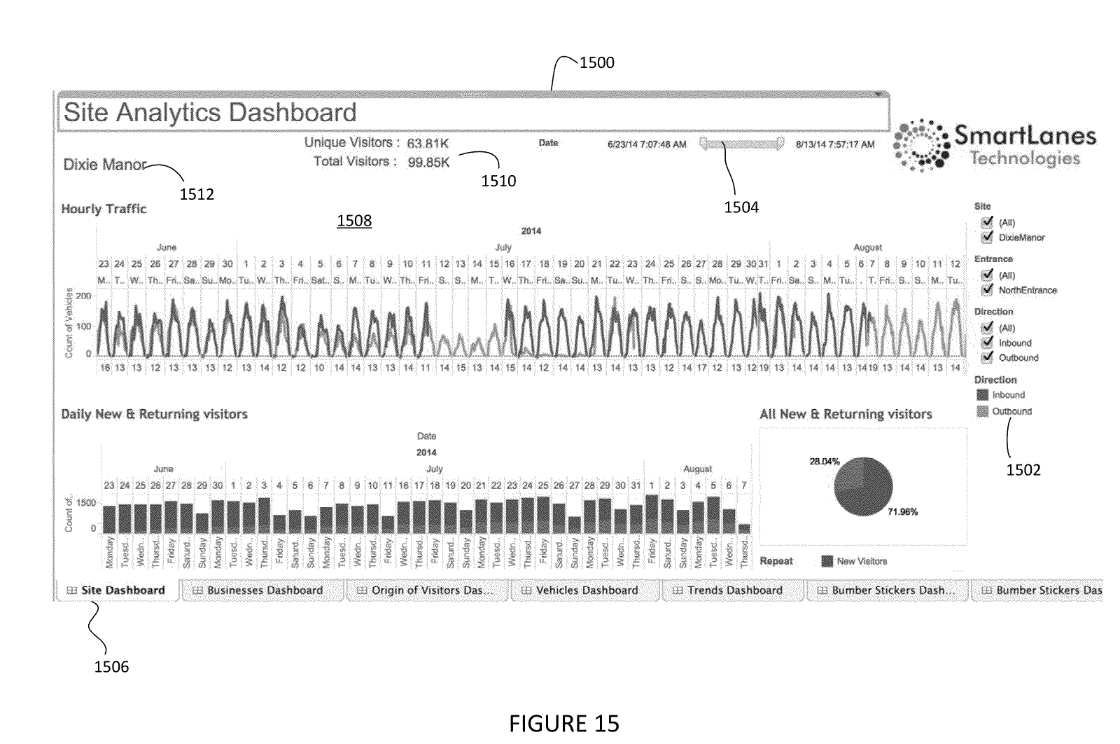

With reference now to FIG. 15, an exemplary screenshot 1500 of a site data dashboard 1508 according to the present invention is provided. The data dashboard 1508 includes data relating to hourly vehicle traffic and daily new and returning visitors. The user may see the location 1512 the data relates to as well as information relating to the total and unique visitors 1510 for that location. The user may customize the dashboard 1508 by using the time slider 1504 and by selecting filtering options from the data filtering menu 1502. The user may also see the currently viewed data dashboard and additional data dashboards on the dashboard tabs list 1506.

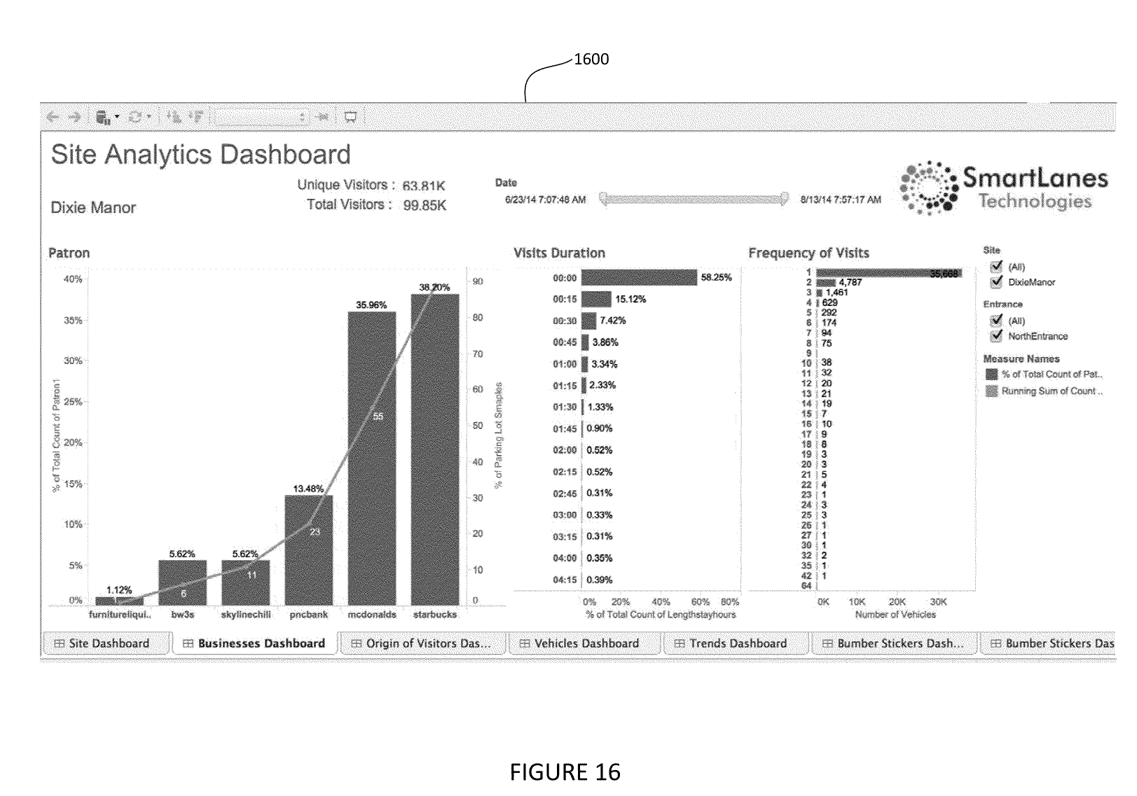

With reference now to FIG. 16, an exemplary screenshot 1600 of a site data dashboard according to the present invention is provided. The business data dashboard includes many of the same filtering features and options of the site data dashboard 1508 of FIG. 15. The data shown, however, relates to the business visited and the duration/frequency of the visits.

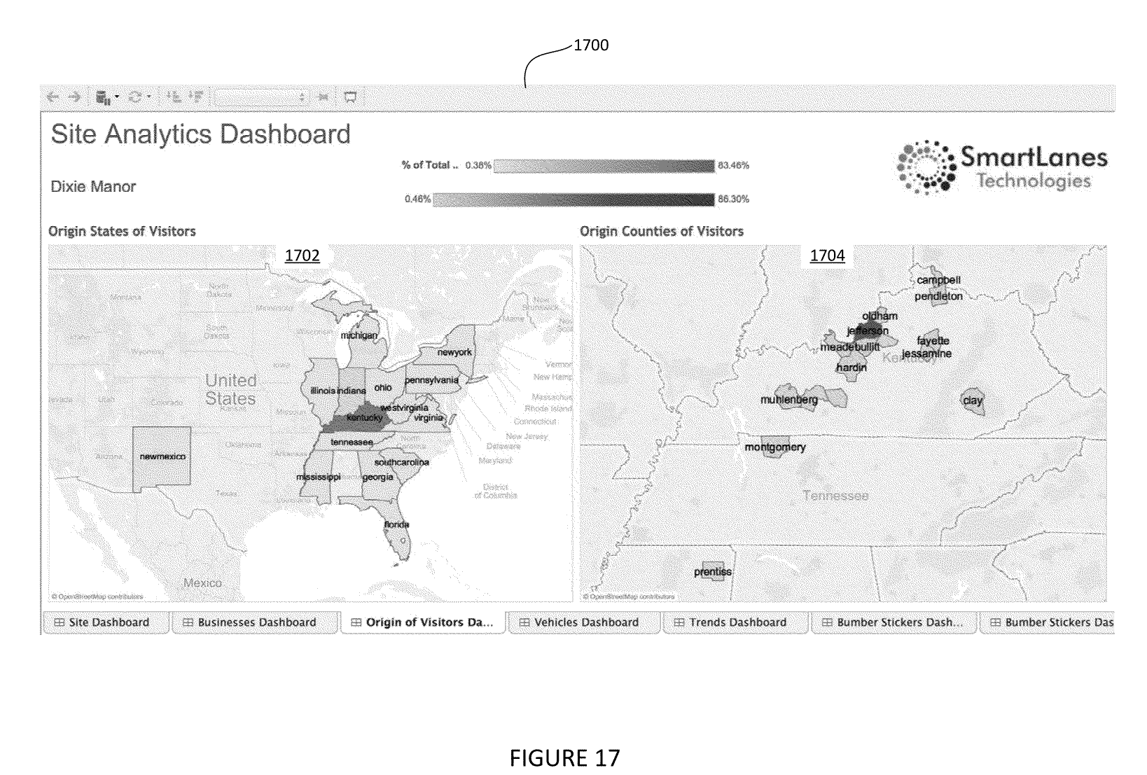

With reference now to FIG. 17, an exemplary screenshot 1700 of an origin of visitors data dashboard according to the present invention is provided. The origin of visitors data dashboard provides the user with one or more maps illustrating to the user the point of origin of the visitors to the user's location. The maps may show county, state, or country of origin. The maps may also be heat maps, with darker areas indicating locations from which users more frequently originate.

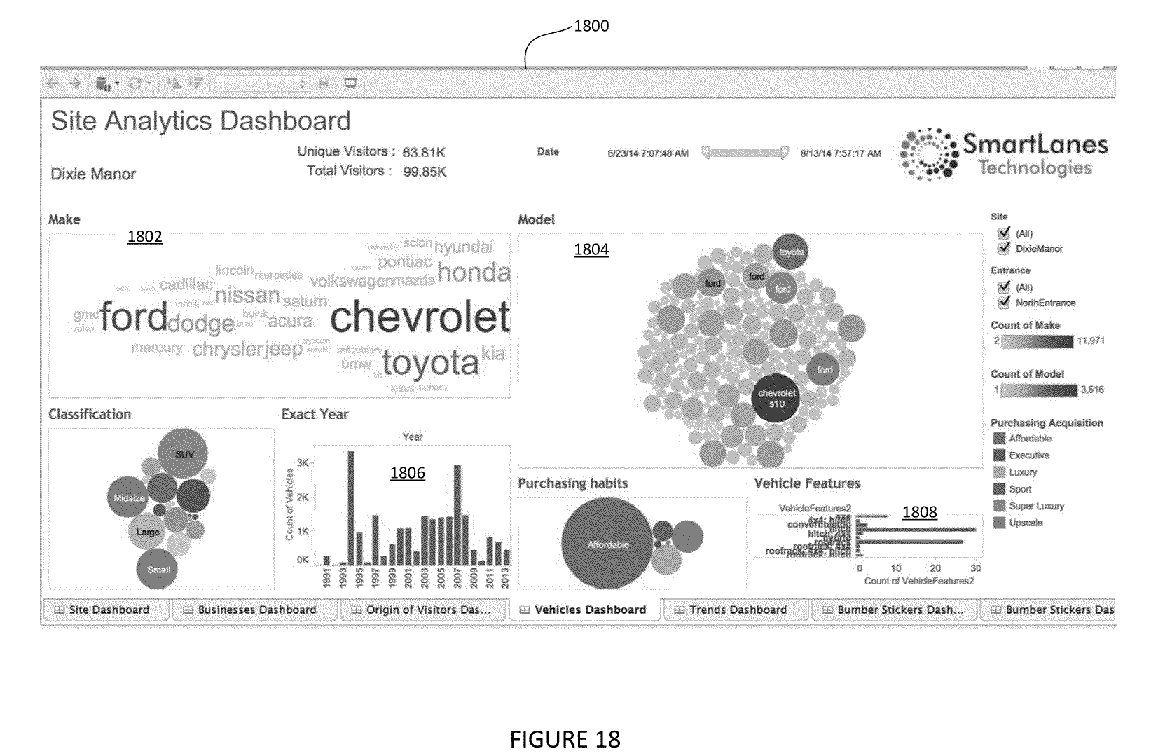

With reference now to FIG. 18, an exemplary screenshot 1800 of a vehicles data dashboard according to the present invention is provided. The vehicles data dashboard shown in the screenshot 1800 may include data relating to the make, model, type of vehicle, year of manufacture, and vehicle features. The make may be shown in the make word cloud 1802. The model may be shown in the relative size graph 1804. The bar graph 1806 provides data relating to the year of manufacture for the vehicle. Features of each vehicle, including features such as four-wheel-drive, convertible, hybrid, etc. may be shown in the vehicle features graph 1808. These graphs may be altered or changed to display the data in a manner better suited to a user's individual needs.

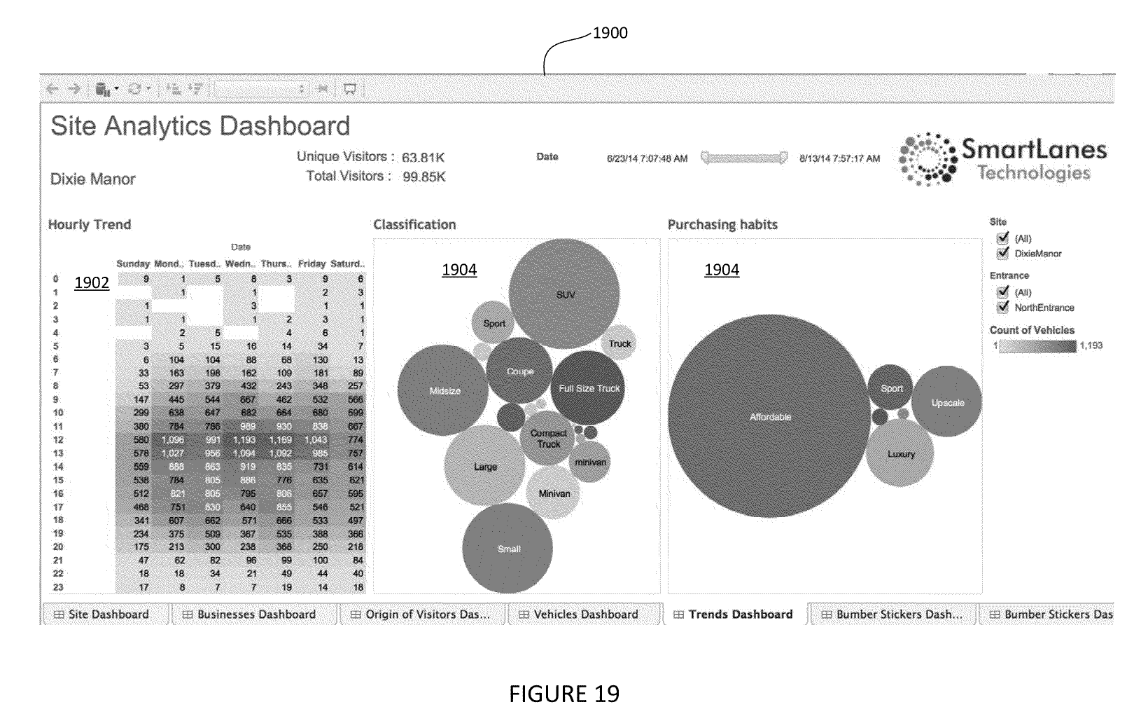

With reference now to FIG. 19, an exemplary screenshot 1900 of a trends data dashboard according to the present invention is provided. The trends data dashboard may include data relating to hourly trends shown on the hourly trend heat map 1902, and data related to vehicle type classification and purchasing habits shown on relative size graphs 1904.

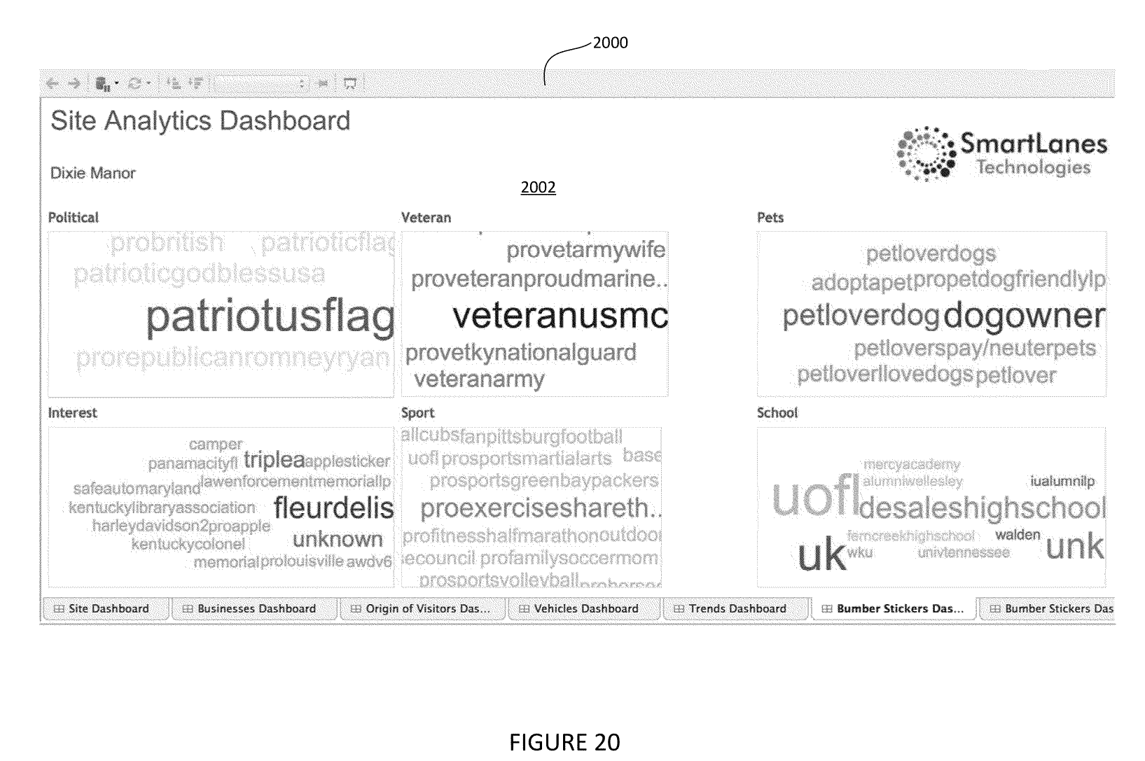

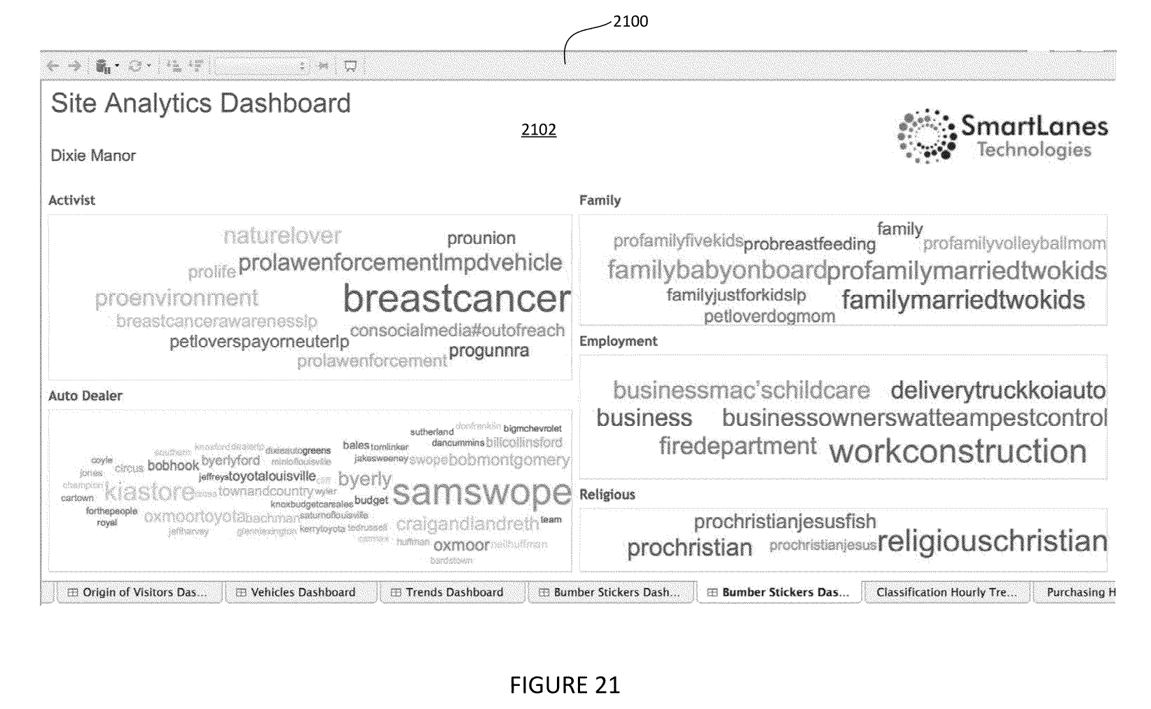

With reference now to FIGS. 20 and 21, exemplary screenshots 2000 and 2100 of bumper stickers data dashboards 2002 and 2102 according to the present invention are provided. The data provided on the bumper stickers data dashboard 2002 and 2102 is primarily shown as word clouds, with the relative size of words indicating those terms that are more predominant in the set of data. This data may aid the user in determining the interests of the visitors or customers that may not otherwise be determinable from vehicle type data and point of origin data alone. The additional data relating to visitor or customer preferences may assist a user in generating marketing materials or advertising more directly relating to the customers' interests. The word clouds may relate to: political interests; veteran/military; pets; sports; schools; activist causes; auto dealerships; family; employment; religion; and other interests.

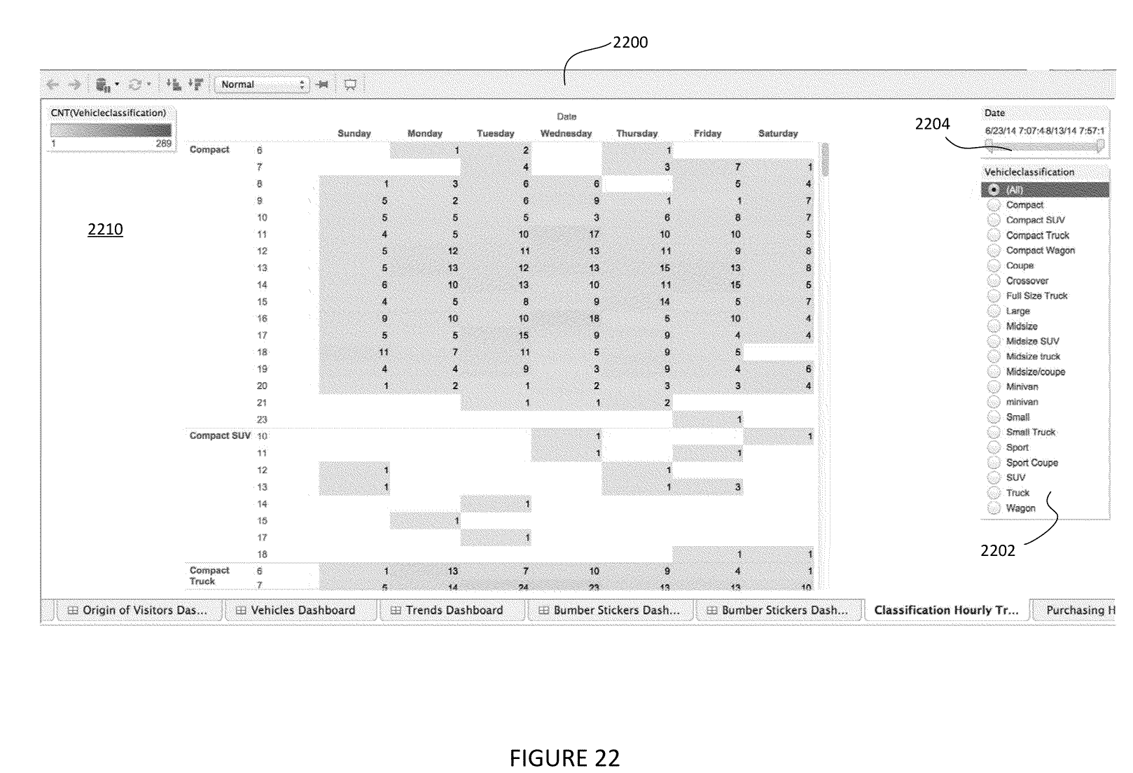

With reference now to FIG. 22, an exemplary screenshot 2200 of a classification hourly trends data dashboard 2210 according to the present invention is provided. The classification hourly trends data dashboard 2210 provides a user with access to an hourly heat map for a selected date range that displays the number of vehicles per hour at a certain site. The user may select the date range with the date slider 2204 and may use the set of radio buttons 2202 to select the type of vehicle to be displayed.

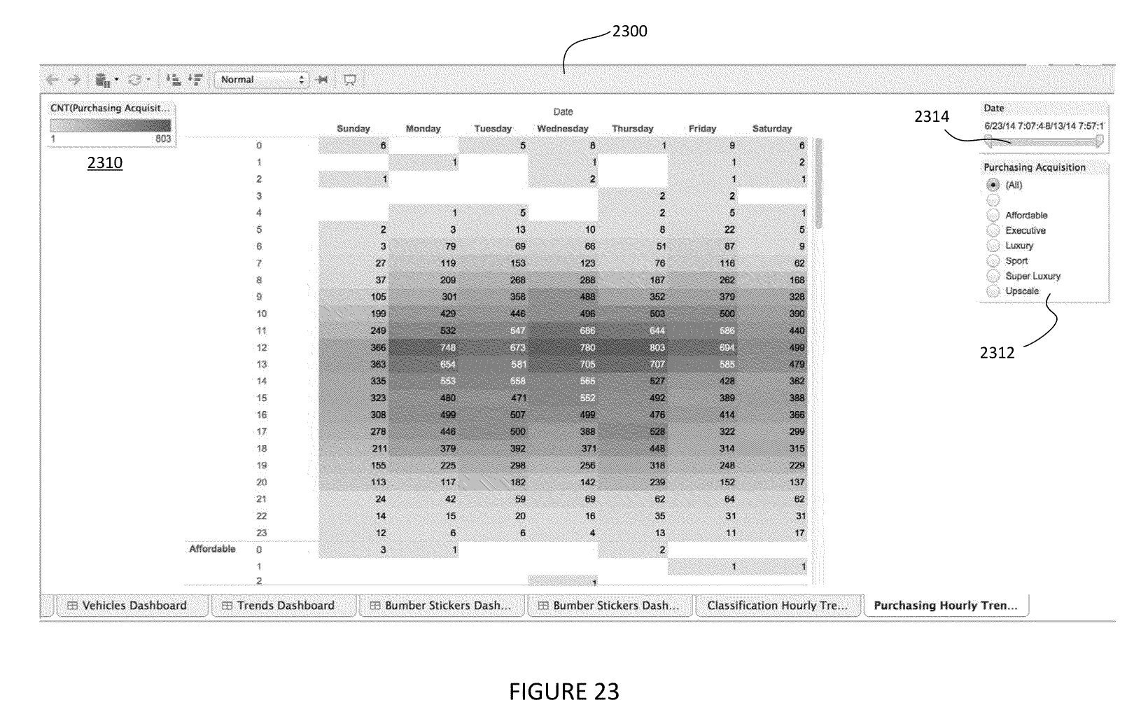

With reference now to FIG. 23, an exemplary screenshot 2300 of a purchasing hourly trends data dashboard 2310 according to the present invention is provided. The purchasing hourly trends data dashboard 2310 provides a user with access to an hourly heat map for a selected date range that displays the types of purchases made per hour at a certain site. The user may select the date range with the date slider 2312 and may use the set of radio buttons 2312 to select the type of purchases to be displayed.

In addition to outputting the data gathered and processed by the system and method of the present invention as a data dashboard, the data may be output or displayed by other means depending on the needs of the user. The data may be output as a data feed that is transmitted to the user, or it may be output as a static report or series of static reports.

The present invention is not to be limited in scope by the specific embodiments described herein. It is fully contemplated that other various embodiments of and modifications to the present invention, in addition to those described herein, will become apparent to those of ordinary skill in the art from the foregoing description and accompanying drawings. Thus, such other embodiments and modifications are intended to fall within the scope of the following appended claims. Further, although the present invention has been described herein in the context of particular embodiments and implementations and applications and in particular environments, those of ordinary skill in the art will appreciate that its usefulness is not limited thereto and that the present invention can be beneficially applied in any number of ways and environments for any number of purposes. Accordingly, the claims set forth below should be construed in view of the full breadth and spirit of the present invention as disclosed herein.

What is claimed is:

1. A system for collecting demographic data, the system comprising:
a set of data collection devices adapted to capture a set of image data from a vehicle;
at least one server communicatively connected through a network to the set of data collection devices, the server comprising:
a database adapted to store data received from the set of data collection devices;
at least one processor adapted to process the set of image data to generate a set of salient objects identified from the set of image data, the at least one processor further adapted to generate a set of processed data from the identified set of salient objects, to generate a set of customer data based in part on the set of customer data, and to associate the set of customer data with a customer;
a collected data database adapted to store the set of customer data; and
an output module adapted to generate and transmit a set of output data comprising data from the set of customer data.

2. The system of claim 1 wherein the set of data collection devices comprises a set of video cameras and a set of wireless network scanning devices.

3. The system of claim 1 wherein the set of processed data comprises customer preferences, vehicle information, residence information.

4. The system of claim 1 wherein the at least one processor is further adapted to:
identify a vehicle license plate number; and
generate an encrypted license plate identifier.

5. The system of claim 1 wherein the at least one processor is further adapted to generate a confidence score.

6. The system of claim 1 wherein the at least one processor is further adapted to perform optical character recognition on the set of data.

7. The system of claim 1 wherein the at least one processor is further adapted to identify the set of salient objects as either image data or text data.

8. The system of claim 1 wherein the at least one processor is further adapted to:
identify images or video sequences in the set of data that contain vehicles;
generate a set of vehicle images; and
determine at least one region of interest in the set of vehicle images.

9. The system of claim 1 wherein the set of data collection devices are mounted on a mobile platform.

10. The system of claim 1 wherein the set of data collection devices are selected from the group consisting of: video cameras, wireless network scanners, and geo-location gathering devices.

11. The system of claim 1 wherein:
the set of data collection devices are further adapted to collected a set of empirical data; and
the at least one processor is further adapted to associate the set of empirical data with the customer.

12. A method for collecting data, the method comprising:
collecting a set of unprocessed data from a set of vehicles at a first location;
transmitting the set of unprocessed data to a temporary storage location;
retrieving the unprocessed data from the temporary storage location;
processing the unprocessed data to generate a set of processed data;
generating a set of preferences from the set of processed data;
associating the set of processed data, the set of unprocessed data, and the set of preferences with one or more entities;
generating a set of reports from the set of processed data and the set of preferences.

13. The method of claim 12 further comprising collecting a set of video data from a set of video cameras and a set of wireless network data from a set of wireless network scanning devices.

14. The method of claim 12 wherein the set of processed data comprises customer preferences, vehicle information, residence information.

15. The method of claim 12 further comprising:
identifying a vehicle license plate number; and
generating an encrypted license plate identifier.

16. The method of claim 12 further comprising generating a confidence score.

17. The method of claim 12 wherein the processing further comprises performing optical character recognition on the set of data.

18. The method of claim 12 further comprising identifying the set of salient objects as either image data or text data.

19. The method of claim 12 further comprising:
identifying images or video sequences in the set of data that contain vehicles;
generating a set of vehicle images; and
determining at least one region of interest in the set of vehicle images.

20. The method of claim 12 wherein the collecting further comprises collecting data from data collection devices mounted on a mobile platform.

21. A method for reducing the size of an image, the method comprising:
a. receiving an image frame from an image capture device;
b. detecting a set of predefined objects in the image;
c. determining the size of each of the objects in the set of predefined objects;
d. generating a compressed image, the generating comprising:
i. determining if each object in the set of objects satisfies a minimum acceptable object size for the object, and if the size of the object does not satisfy the minimum acceptable object size, generating a resized object;
ii. determining if the size of the image frame satisfies a minimum acceptable image size for the frame, and if the size of the image frame does not satisfy the minimum acceptable image size, requesting a resized image from the image capture device;
e. transmitting the compressed image.

22. The method of claim 21 further comprising capturing the image frame at different image sizes.

23. The method of claim 21 further comprising cropping the image frame based on one or more of the detected objects.
